(19) United States
(12) Patent Application Publication
(10) Pub. No.: US 2021/0281745 A1
(43) Pub. Date: Sep. 9, 2021

(54) INFORMATION PROCESSING APPARATUS, INFORMATION PROCESSING METHOD, AND PROGRAM

(71) Applicant: Sony Corporation, Tokyo (JP)

(72) Inventors: Hirofumi HIBI, Tokyo (JP); Hiroyuki MORISAKI, Tokyo (JP)

(73) Assignee: Sony Corporation, Tokyo (JP)

(21) Appl. No.: 17/277,837

(22) PCT Filed: Sep. 24, 2019
(86) PCT No.: PCT/JP2019/037337

§ 371 Date: Mar. 19, 2021

(30) Foreign Application Priority Data
Nov. 13, 2018 (JP) 2018-213348

(51) Int. Cl. H04N 5/232; G06N 3/08; G06K 9/00

(52) U.S. Cl. CPC H04N 5/23219; G06N 3/08; G06K 9/00255; G06K 9/00268; H04N 5/23222

(57) ABSTRACT

An information processing apparatus having a learning unit configured to acquire data, extract, from the data, data in at least a partial range in accordance with a predetermined input, and perform learning on the basis of the data in at least a partial range.

### TECHNICAL FIELD

The present disclosure relates to an information processing apparatus, an information processing method, and a program.

### BACKGROUND ART

Various techniques for evaluating images have been proposed. For example, Patent Document 1 below describes a device that automatically evaluates a composition of an image. In the technique described in Patent Document 1, a composition of an image is evaluated by using a learning file generated by using a learning-type object recognition algorithm.

### CITATION LIST

### Patent Document

Patent Document 1: Japanese Patent Application Laid-Open No. 2006-191524

### SUMMARY OF THE INVENTION

### Problems to be Solved by the Invention

In the technique described in Patent Document 1, since a learning file using an image that is optimal for the purpose and an image that is not suitable for the purpose is constructed, there is a problem that a cost for learning processing (hereinafter, appropriately referred to as a learning cost) is incurred.

One object of the present disclosure is to provide an information processing apparatus, an information processing method, and a program, in which a learning cost is low.

### Solutions to Problems

The present disclosure is, for example,

an information processing apparatus having a learning unit configured to acquire data, extract, from the data, data in at least a partial range in accordance with a predetermined input, and perform learning on the basis of the data in at least a partial range.

Furthermore, the present disclosure is, for example,

an information processing method including: acquiring data; extracting, from the data, data in at least a partial range in accordance with a predetermined input; and performing learning, by a learning unit, on the basis of the data in at least a partial range.

Furthermore, the present disclosure is, for example,

a program for causing a computer to execute an information processing method including: acquiring data; extracting, from the data, data in at least a partial range in accordance with a predetermined input; and performing learning, by a learning unit, on the basis of the data in at least a partial range.

### BRIEF DESCRIPTION OF DRAWINGS

FIG. 1 is a block diagram showing a configuration example of an information processing system according to an embodiment.

FIG. 2 is a block diagram showing a configuration example of an imaging device according to the embodiment.

FIG. 3 is a block diagram showing a configuration example of a camera control unit according to the embodiment.

FIG. 4 is a block diagram showing a configuration example of an automatic shooting controller according to the embodiment.

FIG. 5 is a diagram for explaining an operation example of the information processing system according to the embodiment.

FIG. 6 is a diagram for explaining an operation example of the automatic shooting controller according to the embodiment.

FIG. 7 is a flowchart for explaining an operation example of the automatic shooting controller according to the embodiment.

FIG. 8 is a view showing an example of a UI in which an image segmentation position can be set.

FIG. 9 is a view showing an example of a UI used for learning a field angle.

FIG. 10 is a flowchart referred to in describing a flow of a process of learning a field angle performed by a learning unit according to the embodiment.

FIG. 11 is a flowchart referred to in describing a flow of the process of learning a field angle performed by the learning unit according to the embodiment.

FIG. 12 is a view showing an example of a UI in which a generated learning model and the like are displayed.

FIG. 13 is a diagram for explaining a first modification.

FIG. 14 is a diagram for explaining a second modification.

FIG. 15 is a flowchart showing a flow of a process performed in the second modification.

FIG. 16 is a diagram schematically showing an overall configuration of an operating room system.

FIG. 17 is a view showing a display example of an operation screen on a centralized operation panel.

FIG. 18 is a diagram showing an example of a state of operation to which the operating room system is applied.

FIG. 19 is a block diagram showing an example of a functional configuration of a camera head and a CCU shown in FIG. 18.

### MODE FOR CARRYING OUT THE INVENTION

Hereinafter, an embodiment and the like of the present disclosure will be described with reference to the drawings. Note that the description will be given in the following order.

### Embodiment

<Modification>

<Application Example>

The embodiment and the like described below are preferred specific examples of the present disclosure, and the contents of the present disclosure are not limited to the embodiment and the like.

### Embodiment

[Configuration Example of Information Processing System]

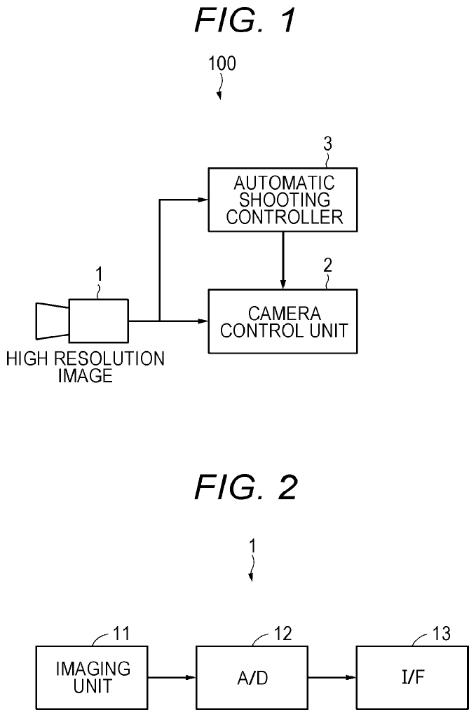

FIG. 1 is a diagram showing a configuration example of an information processing system (an information processing system 100) according to an embodiment. The information processing system 100 has a configuration including, for example, an imaging device 1, a camera control unit 2, and an automatic shooting controller 3. Note that the camera control unit may also be referred to as a baseband processor or the like.

The imaging device 1, the camera control unit 2, and the automatic shooting controller 3 are connected to each other by wire or wirelessly, and can send and receive data such as commands and image data to and from each other. For example, under control of the automatic shooting controller 3, automatic shooting (more specifically, studio shooting) is performed on the imaging device 1. Examples of the wired connection include a connection using an optical-electric composite cable and a connection using an optical fiber cable. Examples of the wireless connection include a local area network (LAN), Bluetooth (registered trademark), Wi-Fi (registered trademark), a wireless USB (WUSB), and the like. Note that an image (a shot image) shot by the imaging device 1 may be a moving image or a still image. The imaging device 1 acquires a high resolution image (for example, an image referred to as 4K or 8K).

[Configuration Example of Each Device Included in Information Processing System]

(Configuration Example of Imaging Device)

Next, a configuration example of each device included in the information processing system 100 will be described. First, a configuration example of the imaging device 1 will be described. FIG. 2 is a block diagram showing a configuration example of the imaging device 1. The imaging device 1 includes an imaging unit 11, an A/D conversion unit 12, and an interface (I/F) 13.

The imaging unit 11 has a configuration including an imaging optical system such as lenses (including a mechanism for driving these lenses) and an image sensor. The image sensor is a charge coupled device (CCD), a complementary metal oxide semiconductor (CMOS), or the like. The image sensor photoelectrically converts an object light incident through the imaging optical system into a charge quantity, to generate an image.

The A/D conversion unit 12 converts an output of the image sensor in the imaging unit 11 into a digital signal, and outputs the digital signal. The A/D conversion unit 12 converts, for example, pixel signals for one line into digital signals at the same time. Note that the imaging device 1 may have a memory that temporarily holds the output of the A/D conversion unit 12.

The I/F 13 provides an interface between the imaging device 1 and an external device. Via the I/F 13, a shot image is outputted from the imaging device 1 to the camera control unit 2 and the automatic shooting controller 3.

(Configuration Example of Camera Control Unit)

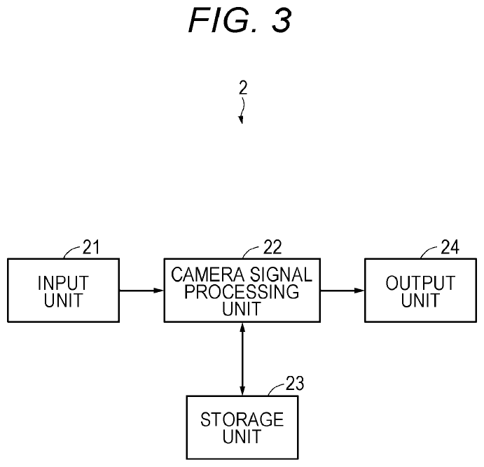

FIG. 3 is a block diagram showing a configuration example of the camera control unit 2. The camera control unit 2 has, for example, an input unit 21, a camera signal processing unit 22, a storage unit 23, and an output unit 24.

The input unit 21 is an interface to be inputted with commands and various data from an external device.

The camera signal processing unit 22 performs known camera signal processing such as white balance adjustment processing, color correction processing, gamma correction processing, Y/C conversion processing, and auto exposure (AE) processing. Furthermore, the camera signal processing unit 22 performs image segmentation processing in accordance with control by the automatic shooting controller 3, to generate an image having a predetermined field angle.

The storage unit 23 stores image data or the like subjected to camera signal processing by the camera signal processing unit 22. Examples of the storage unit 23 include a magnetic storage device such as a hard disk drive (HDD), a semiconductor storage device, an optical storage device, a magneto-optical storage device, or the like.

The output unit 24 is an interface to output image data or the like subjected to the camera signal processing by the camera signal processing unit 22. Note that the output unit 24 may be a communication unit that communicates with an external device.

(Configuration Example of Automatic Shooting Controller)

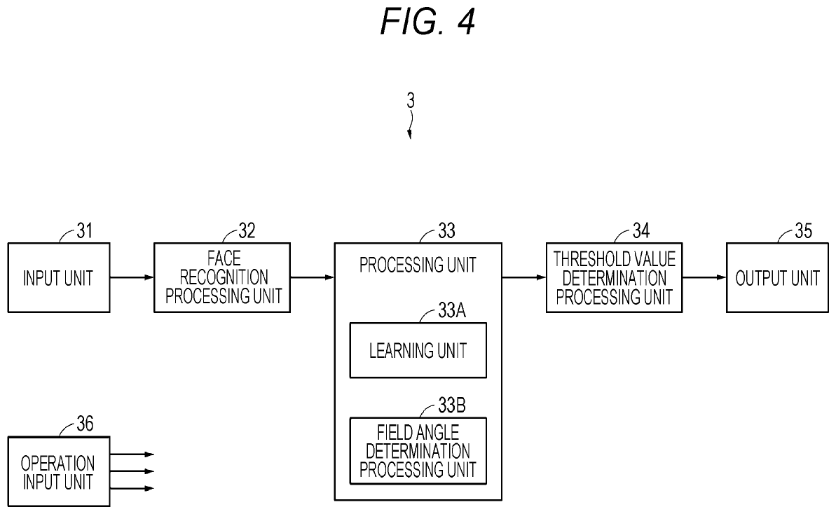

FIG. 4 is a block diagram showing a configuration example of the automatic shooting controller 3, which is an example of an information processing apparatus. The automatic shooting controller 3 is configured by a personal computer, a tablet-type computer, a smartphone, or the like. The automatic shooting controller 3 has, for example, an input unit 31, a face recognition processing unit 32, a processing unit 33, a threshold value determination processing unit 34, an output unit 35, and an operation input unit 36. The processing unit 33 has a learning unit 33A and a field angle determination processing unit 33B. In the present embodiment, the processing unit 33 and the threshold value determination processing unit 34 correspond to a determination unit in the claims, and the operation input unit 36 corresponds to an input unit in the claims.

The automatic shooting controller 3 according to the present embodiment performs a process corresponding to a control phase and a process corresponding to a learning phase. The control phase is a phase of using a learning model generated by the learning unit 33A to perform evaluation, and generating an image during on-air with a result determined to be appropriate (for example, an appropriate field angle) as a result of the evaluation. The on-air means shooting for acquiring an image that is currently being broadcast or will be broadcast in the future. The learning phase is a phase of learning by the learning unit 33A. The learning phase is a phase to be entered when there is an input for instructing a learning start.

The processes respectively related to the control phase and the learning phase may be performed in parallel at the same time, or may be performed at different timings. The following patterns are assumed as a case where the processes respectively related to the control phase and the learning phase are performed at the same time.

For example, when a trigger is given for switching to a mode of shifting to the learning phase during on-air, teacher data is created and learned on the basis of images during that period. A learning result is reflected in the process in the control phase during the same on-air after a learning end.

The following patterns are assumed as a case where the processes respectively related to the control phase and the learning phase are performed at different timings.

For example, teacher data collected during one time of on-air (in some cases, for multiple times of on-air) is learned after being accumulated in a storage unit (for example, a storage unit of the automatic shooting controller 3) or the like, and this learning result will be used in the control phase at on-air of the next time and thereafter.

The timings for ending (triggers for ending) the processes related to the control phase and the learning phase may be simultaneous or different.

On the basis of the above, a configuration example and the like of the automatic shooting controller 3 will be described.

The input unit 31 is an interface to be inputted with commands and various data from an external device.

The face recognition processing unit 32 detects a face region, which is an example of a feature, by performing known face recognition processing on image data inputted via the input unit 31 in response to a predetermined input (for example, an input for instructing a shooting start). Then, a feature image in which the face region is symbolized is generated. Here, symbolizing means to distinguish between a feature portion and other portion. The face recognition processing unit 32 generates, for example, a feature image in which a detected face region and a region other than the face region are binarized at different levels. The generated feature image is used for the process in the control phase. Furthermore, the generated feature image is also used for a process in the learning phase.

As described above, the processing unit 33 has the learning unit 33A and the field angle determination processing unit 33B. The learning unit 33A and the field angle determination processing unit 33B operate on the basis of an algorithm using an autoencoder, for example. The autoencoder is a mechanism to learn a neural network that can efficiently perform dimensional compression of data by optimizing network parameters so that an output reproduces an input as much as possible, in other words, a difference between the input and the output is 0.

The learning unit 33A acquires the generated feature image, extracts data in at least a partial range of image data of the feature image acquired in response to a predetermined input (for example, an input for instructing a learning start point), and performs learning on the basis of the extracted image data in at least a partial range. Specifically, the learning unit 33A performs learning in accordance with an input for instructing a learning start, on the basis of image data of the feature image generated on the basis of a correct answer image that is an image desired by a user, specifically, a correct answer image (in the present embodiment, an image having an appropriate field angle) acquired via the input unit 31 during shooting. More specifically, the learning unit 33A uses, as learning target image data (teacher data), a feature image in which the image data corresponding to the correct answer image is reconstructed by the face recognition processing unit 32 (in the present embodiment, a feature image in which a face region and other regions are binarized), and performs learning in accordance with an input for instructing a learning start. Note that the predetermined input may include an input for instructing a learning end point, in addition to the input for instructing a learning start point. In this case, the learning unit 33A extracts image data in a range from the learning start point to the learning end point, and performs learning on the basis of the extracted image data. Furthermore, the learning start point may indicate a timing at which the learning unit 33A starts learning, or may indicate a timing at which the learning unit 33A starts acquiring teacher data to be used for learning. Similarly, the learning end point may indicate a timing at which the learning unit 33A ends learning, or may indicate a timing at which the learning unit 33A ends acquiring teacher data to be used for learning.

Note that the learning in the present embodiment means generating a model (a neural network) for outputting an evaluation value by using a binarized feature image as an input.

The field angle determination processing unit 33B uses a learning result obtained by the learning unit 33A, and uses a feature image generated by the face recognition processing unit 32, to calculate an evaluation value for a field angle of image data obtained via the input unit 31. The field angle determination processing unit 33B outputs the calculated evaluation value to the threshold value determination processing unit 34.

The threshold value determination processing unit 34 compares the evaluation value outputted from the field angle determination processing unit 33B with a predetermined threshold value. Then, on the basis of a comparison result, the threshold value determination processing unit 34 determines whether or not a field angle in the image data acquired via the input unit 31 is appropriate. For example, in a case where the evaluation value is smaller than the threshold value as a result of the comparison, the threshold value determination processing unit 34 determines that the field angle in the image data acquired via the input unit 31 is appropriate. Furthermore, in a case where the evaluation value is larger than the threshold value as a result of the comparison, the threshold value determination processing unit 34 determines that the field angle in the image data acquired via the input unit 31 is inappropriate. In a case where it is determined that the field angle is inappropriate, the threshold value determination processing unit 34 outputs a segmentation position instruction command that specifies an image segmentation position, in order to obtain an appropriate field angle. Note that the processes in the field angle determination processing unit 33B and the threshold value determination processing unit 34 are performed in the control phase.

The output unit 35 is an interface that outputs data and commands generated by the automatic shooting controller 3. Note that the output unit 35 may be a communication unit that communicates with an external device (for example, a server device). For example, via the output unit 35, the segmentation position instruction command described above is outputted to the camera control unit 2.

The operation input unit 36 is a user interface (UI) that collectively refers to configurations that accept operation inputs. The operation input unit 36 has, for example, an operation part such as a display part, a button, and a touch panel.

[Operation Example of Information Processing System]

(Operation Example of Entire Information Processing System)

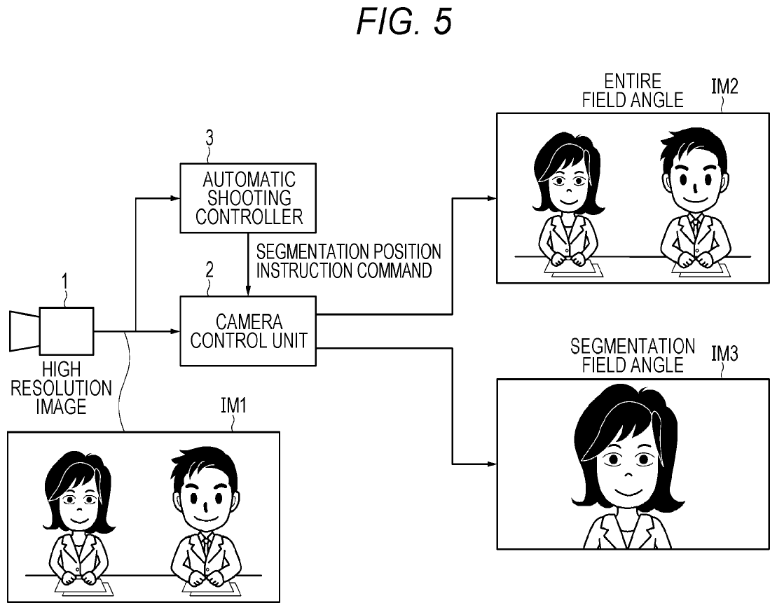

Next, an operation example of the information processing system 100 according to the embodiment will be described. The following description is an operation example of the information processing system 100 in the control phase. FIG. 5 is a diagram for explaining an operation example performed by the information processing system 100. By the imaging device 1 performing an imaging operation, an image is acquired. A trigger for the imaging device 1 to start acquiring an image may be a predetermined input to the imaging device 1, or may be a command transmitted from the automatic shooting controller 3. As shown in FIG. 5, for example, a two shot image IM1 in which two people are captured is acquired by the imaging device 1. The image acquired by the imaging device 1 is supplied to each of the camera control unit 2 and the automatic shooting controller 3.

The automatic shooting controller 3 determines whether or not a field angle of the image IM1 is appropriate. In a case where the field angle of the image IM1 is appropriate, the image IM1 is stored in the camera control unit 2 or outputted from the camera control unit 2 to another device. In a case where the field angle of the image IM1 is inappropriate, a segmentation position instruction command is outputted from the automatic shooting controller 3 to the camera control unit 2. The camera control unit 2 having received the segmentation position instruction command segments the image at a position corresponding to the segmentation position instruction command. As shown in FIG. 5, the field angle of the image that is segmented in response to the segmentation position instruction command may be the entire field angle (an image IM2 shown in FIG. 5), a one shot image in which one person is captured (an image IM3 shown in FIG. 5), or the like.

(Operation Example of Automatic Shooting Controller)

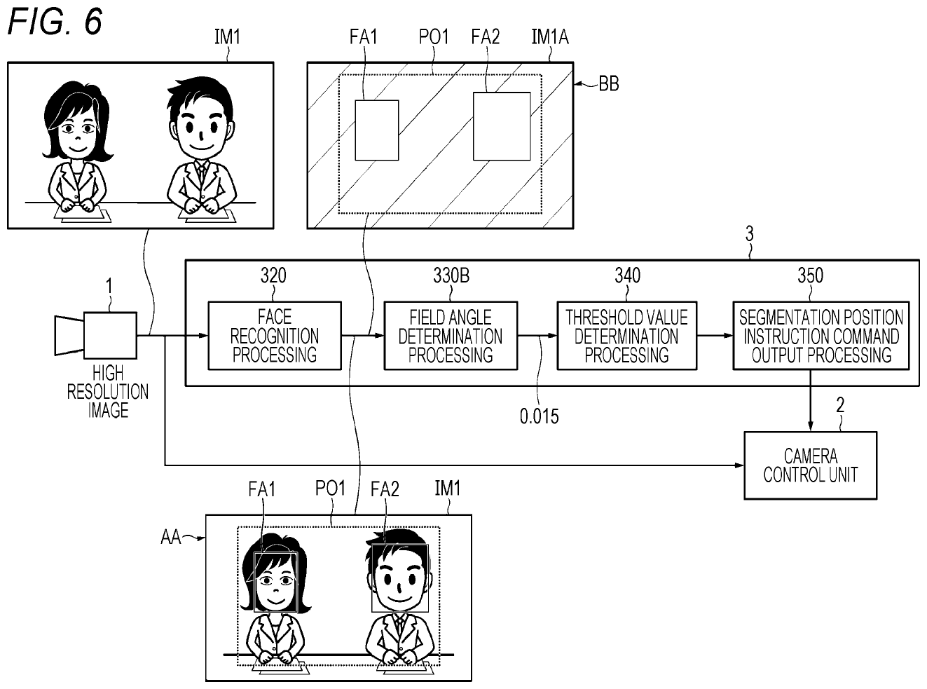

Next, with reference to FIG. 6, an operation example of the automatic shooting controller in the control phase will be described. As described above, for example, the image IM1 is acquired by the imaging device 1. The image IM1 is inputted to the automatic shooting controller 3. The face recognition processing unit 32 of the automatic shooting controller 3 performs face recognition processing 320 on the image IM1. As the face recognition processing 320, known face recognition processing can be applied. The face recognition processing 320 detects a face region FA1 and a face region FA2, which are face regions of people in the image IM1, as schematically shown at a portion given with reference numeral AA in FIG. 6.

Then, the face recognition processing unit 32 generates a feature image in which the face region FA1 and the face region FA2, which are examples of a feature, are symbolized. For example, as shown schematically at a portion given with reference numeral BB in FIG. 6, a binarized image IM1A is generated in which the face region FA1 and the face region FA2 are distinguished from other regions. The face region FA1 and the face region FA2 are defined by, for example, a white level, and a non-face region (a hatched region) is defined by a black level. An image segmentation position PO1 of the binarized image IM1A is inputted to the field angle determination processing unit 33B of the processing unit 33. Note that the image segmentation position PO1 is, for example, a range preset as a position for segmentation of a predetermined range with respect to a detected face region (in this example, the face region FA1 and the face region FA2).

The field angle determination processing unit 33B calculates an evaluation value for the field angle of the image IM1 on the basis of the image segmentation position PO1. The evaluation value for the field angle of the image IM1 is calculated using a learning model that has been learned. As described above, in the present embodiment, the evaluation value is calculated by the autoencoder. In a method using the autoencoder, a model is used in which data is compressed and reconstructed with as little loss as possible by utilizing a relationship and a pattern between normal data. In a case where normal data, that is, image data with an appropriate field angle, is processed using this model, the data loss is small. In other words, a difference between original data before compression and data after reconstruction becomes small. In the present embodiment, this difference corresponds to the evaluation value. That is, as the field angle of the image is more appropriate, the evaluation value becomes smaller. Whereas, in a case where abnormal data, that is, image data with an inappropriate field angle is processed, the data loss becomes large. In other words, the evaluation value that is a difference between original data before compression and data after reconstruction becomes large. The field angle determination processing unit 33B outputs the obtained evaluation value to the threshold value determination processing unit 34. In the example shown in FIG. 6, “0.015” is shown as an example of the evaluation value.

The threshold value determination processing unit 34 performs threshold value determination processing 340 for comparing an evaluation value supplied from the field angle determination processing unit 33B with a predetermined threshold value. As a result of the comparison, in a case where the evaluation value is larger than the threshold value, it is determined that the field angle of the image IM1 is inappropriate. Then, segmentation position instruction command output processing 350 is performed, in which a segmentation position instruction command indicating an image segmentation position for achieving an appropriate field angle is outputted via the output unit 35. The segmentation position instruction command is supplied to the camera control unit 2. Then, the camera signal processing unit 22 of the camera control unit 2 executes, on the image IM1, a process of segmenting an image at a position indicated by the segmentation position instruction command. Note that, as a result of the comparison, in a case where the evaluation value is smaller than the threshold value, the segmentation position instruction command is not outputted.

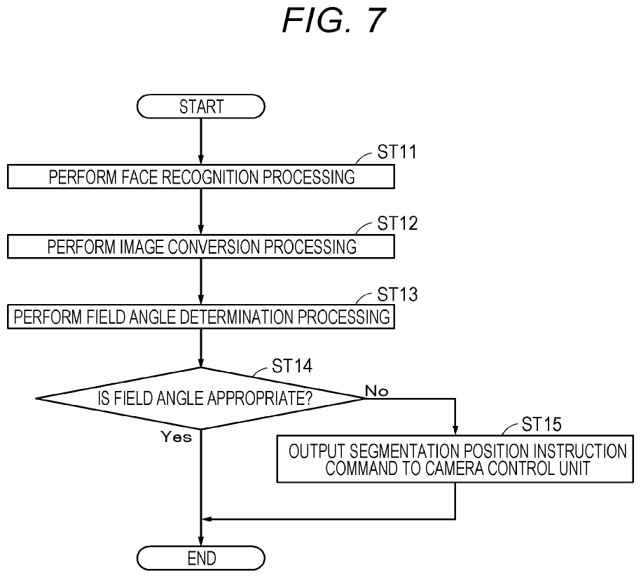

FIG. 7 is a flowchart showing a flow of a process performed by the automatic shooting controller 3 in the control phase. When the process is started, in step ST11, the face recognition processing unit 32 performs face recognition processing on an image acquired via the imaging device 1. Then, the process proceeds to step ST12.

In step ST12, the face recognition processing unit 32 performs image conversion processing, and such processing generates a feature image such as a binarized image. An image segmentation position in the feature image is supplied to the field angle determination processing unit 33B. Then, the process proceeds to step ST13.

In step ST13, the field angle determination processing unit 33B obtains an evaluation value, and the threshold value determination processing unit 34 performs the threshold value determination processing. Then, the process proceeds to step ST14.

In step ST14, as a result of the threshold value determination processing, it is determined whether or not a field angle is appropriate. In a case where the field angle is appropriate, the process ends. In a case where the field angle is inappropriate, the process proceeds to step ST15.

In step ST15, the threshold value determination processing unit 34 outputs the segmentation position instruction command to the camera control unit 2 via the output unit 35. Then, the process ends.

Note that the appropriate field angle differs every shot. Therefore, the field angle determination processing unit 33B and the threshold value determination processing unit 34 may determine whether or not the field angle is appropriate every shot. Specifically, it may be determined whether or not the field angle is appropriate in response to a field angle of a one shot or a field angle of a two shot desired to be shot by the user, by providing a plurality of field angle determination processing units 33B and threshold value determination processing units 34 so as to determine the field angle every shot.

[Setting of Image Segmentation Position]

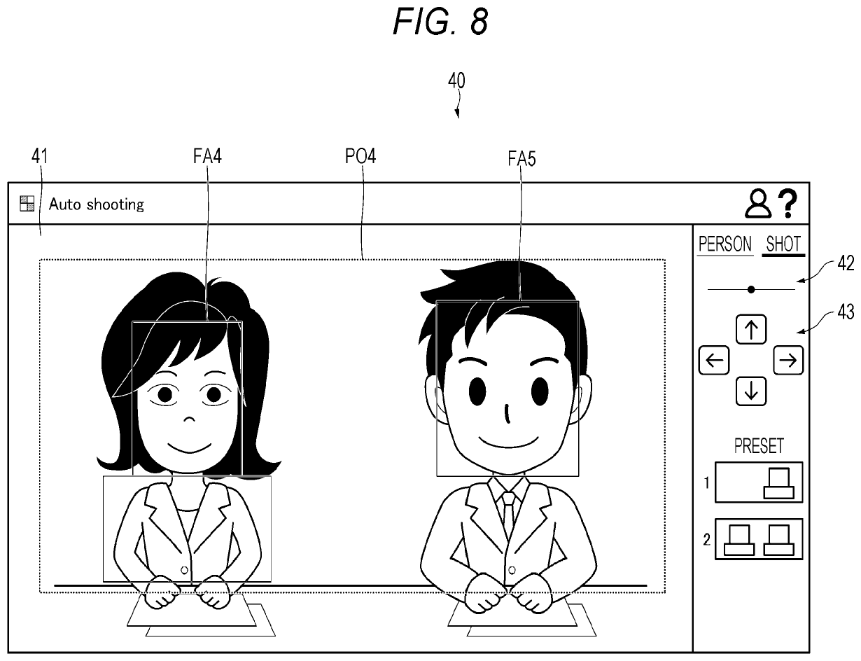

Next, a description will be given to an example of adjusting an image segmentation position specified by the segmentation position instruction command, that is, adjusting a field angle, and setting an adjusted result. FIG. 8 is a view showing an example of a UI (a UI 40) in which a segmentation position of an image can be set. The UI 40 includes a display part 41, and the display part 41 displays two people and face regions (face regions FA4 and FA5) of the two people. Furthermore, the display part 41 shows an image segmentation position PO4 with respect to the face regions FA4 and FA5.

Furthermore, on the right side of the display part 41, a zoom adjustment part 42 including one circle displayed on a linear line is displayed. A display image of the display part 41 is zoomed in by moving the circle to one end, and the display image of the display part 41 is zoomed out by moving the circle to the other end. On a lower side of the zoom adjustment part 42, a position adjustment part 43 including a cross key is displayed. By appropriately operating the cross key of the position adjustment part 43, a position of the image segmentation position PO4 can be adjusted.

Note that, although FIG. 8 shows the UI for adjusting a field angle of a two shot, it is also possible to adjust a field angle of a one shot or the like using the UI 40. The user can use the operation input unit 36 to appropriately operate the zoom adjustment part 42 and the position adjustment part 43 in the UI 40, to enable field angle adjustment corresponding to each shot, such as having a space on left, having a space on right, or zooming. Note that a field angle adjustment result obtained by using the UI 40 can be saved, and may be recalled later as a preset.

[About Learning of Field Angle]

Next, a description will be given to learning of a field angle performed by the learning unit 33A of the automatic shooting controller 3, that is, the process in the learning phase. The learning unit 33A learns, for example, a correspondence between scenes and at least one of a shooting condition or an editing condition for each of the scenes. Here, the scene includes a composition. The composition is a configuration of the entire screen during shooting. Specifically, examples of the composition include a positional relationship of a person with respect to a field angle, more specifically, such as a one shot, a two shot, a one shot having a space on left, and a one shot having a space on right. Such a scene can be specified by the user as described later. The shooting condition is a condition that may be adjusted during shooting, and specific examples thereof include screen brightness (iris gain), zoom, or the like. The editing condition is a condition that may be adjusted during shooting or recording check, and specific examples thereof include a segmentation field angle, brightness (gain), and image quality. In the present embodiment, an example of learning of a field angle, which is one of the editing conditions, will be described.

The learning unit 33A performs learning in response to an input for instructing a learning start, on the basis of data (in the present embodiment, image data) acquired in response to a predetermined input. For example, consider an example in which studio shooting is performed using the imaging device 1. In this case, since an image is used for broadcasting or the like during on-air (during shooting), it is highly possible that a field angle for performers is appropriate. Whereas, in a case of not during on-air, the imaging device 1 is not moved even if an image is being acquired by the imaging device 1, and there is a high possibility that facial expressions of performers will remain relaxed and the movements will be different. That is, for example, a field angle of the image acquired during on-air is likely to be appropriate, whereas a field angle of the image acquired in a case of not during on-air is likely to be inappropriate.

Therefore, the learning unit 33A learns the former as a correct answer image. Learning by using only a correct answer image without using an incorrect answer image enables reduction of a learning cost when the learning unit 33A learns. Furthermore, it is not necessary to give image data with a tag of a correct answer or an incorrect answer, and it is not necessary to acquire incorrect answer images.

Furthermore, in the present embodiment, the learning unit 33A performs learning by using, as the learning target image data, a feature image (for example, a binarized image) generated by the face recognition processing unit 32. By using an image in which a feature such as a face region is symbolized, the learning cost can be reduced. In the present embodiment, since the feature image generated by the face recognition processing unit 32 is used as the learning target image data, the face recognition processing unit 32 functions as a learning target image data generation unit. Of course, other than the face recognition processing unit 32, a functional block corresponding to the learning target image data generation unit may be provided. Hereinafter, learning performed by the learning unit 33A will be described in detail.

(Example of UI Used in Learning Field Angle)

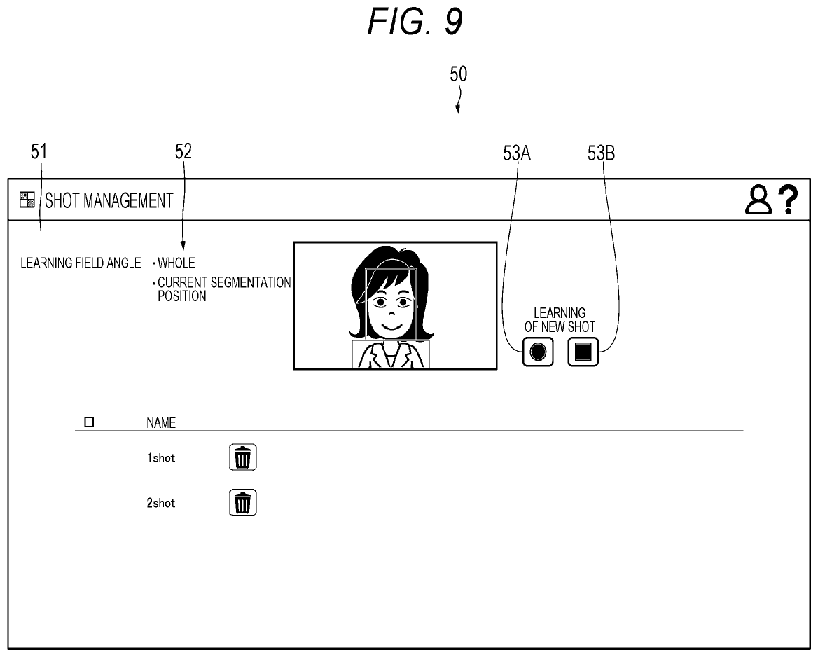

FIG. 9 is a diagram showing an example of a UI (a UI 50) used in learning a field angle by the automatic shooting controller 3. The UI 50 is, for example, a UI for causing the learning unit 33A to learn a field angle of a one shot. A scene of a learning target can be appropriately changed by, for example, an operation using the operation input unit 36. The UI 50 includes, for example, a display part 51 and a learning field angle selection part 52 displayed on the display part 51. The learning field angle selection part 52 is a UI that enables specification of a range of learning target image data (in the present embodiment, a feature image) used for learning, in which, in the present embodiment, “whole” and “current segmentation position” can be selected. When “whole” of the learning field angle selection part 52 is selected, the entire feature image is used for learning. When “current segmentation position” of the learning field angle selection part 52 is selected, a feature image segmented at a predetermined position is used for learning. The image segmentation position here is, for example, a segmentation position set using FIG. 8.

The UI 50 further includes, for example, a shooting start button 53A and a learn button 53B displayed on the display part 51. The shooting start button 53A is, for example, a button (a record button) marked with a red circle, and is for instructing a shooting start. The learn button 53B is, for example, a rectangular button for instructing a learning start. When an input of pressing the shooting start button 53A is made, shooting by the imaging device 1 is started, and a feature image is generated on the basis of image data acquired by the shooting. When the learn button 53B is pressed, learning is performed by the learning unit 33A using the generated feature image. Note that the shooting start button 53A does not need to be linked to a shooting start, and may be operated at any timing.

(Flow of Process of Learning Field Angle)

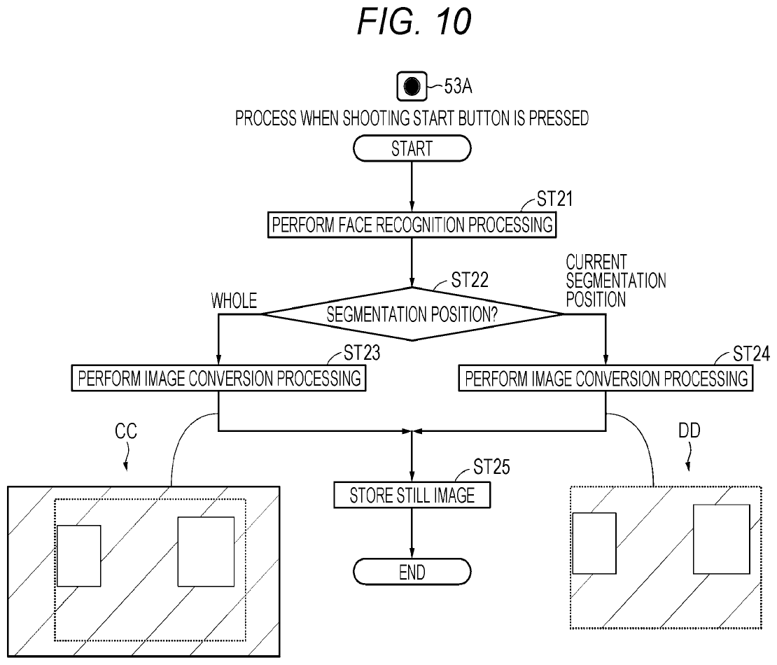

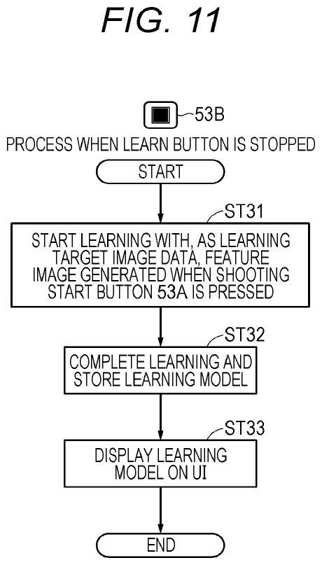

Next, with reference to flowcharts of FIGS. 10 and 11, a flow of a process performed by the learning unit 33A in the learning phase will be described. FIG. 10 is a flowchart showing a flow of a process performed when the shooting start button 53A is pressed to instruct a shooting start. When the process is started, an image acquired via the imaging device 1 is supplied to the automatic shooting controller 3 via the input unit 31. In step ST22, a face region is detected by the face recognition processing by the face recognition processing unit 32. Then, the process proceeds to step ST22.

In step ST22, the face recognition processing unit 32 checks setting of the learning field angle selection part 52 in the UI 50. In a case where the setting of the learning field angle selection part 52 is “whole”, the process proceeds to step ST23. In step ST23, the face recognition processing unit 32 performs image conversion processing for generating a binarized image of the entire image, as schematically shown at a portion given with reference numeral CC in FIG. 10. Then, the process proceeds to step ST25, and the binarized image (a still image) of the entire generated image is stored (saved). The binarized image of the entire image may be stored in the automatic shooting controller 3, or may be transmitted to an external device via the output unit 35 and stored in the external device.

In the determination processing of step ST22, in a case where the setting of the learning field angle selection part 52 is “current segmentation position”, the process proceeds to step ST24. In step ST24, the face recognition processing unit 32 performs image conversion processing to generate a binarized image of the image segmented at a predetermined segmentation position as schematically shown in a portion given with reference numeral DD in FIG. 10. Then, the process proceeds to step ST25, and the binarized image (a still image) of the generated segmented image is stored (saved). Similarly to the binarized image of the entire image, the binarized image of the segmented image may be stored in the automatic shooting controller 3, or may be transmitted to an external device via the output unit 35 and stored in the external device.

FIG. 11 is a flowchart showing a flow of a process performed when the learn button 53B is pressed to instruct a learning start, that is, when the learning phase is entered. When the process is started, in step ST31, the learning unit 33A starts learning by using, as learning target image data, a feature image generated when the shooting start button 53A is pressed, specifically, the feature image generated in step ST23 and step ST24 and stored in step ST25. Then, the process proceeds to step ST32.

In the present embodiment, the learning unit 33A performs learning by the autoencoder. In step ST32, the learning unit 33A performs compression and reconstruction processing on the learning target image data prepared for learning, to generate a model (a learning model) that matches the learning target image data. When the learning by the learning unit 33A is ended, the generated learning model is stored (saved) in a storage unit (for example, a storage unit of the automatic shooting controller 3). The generated learning model may be outputted to an external device via the output unit 35, and the learning model may be stored in the external device. Then, the process proceeds to step ST33.

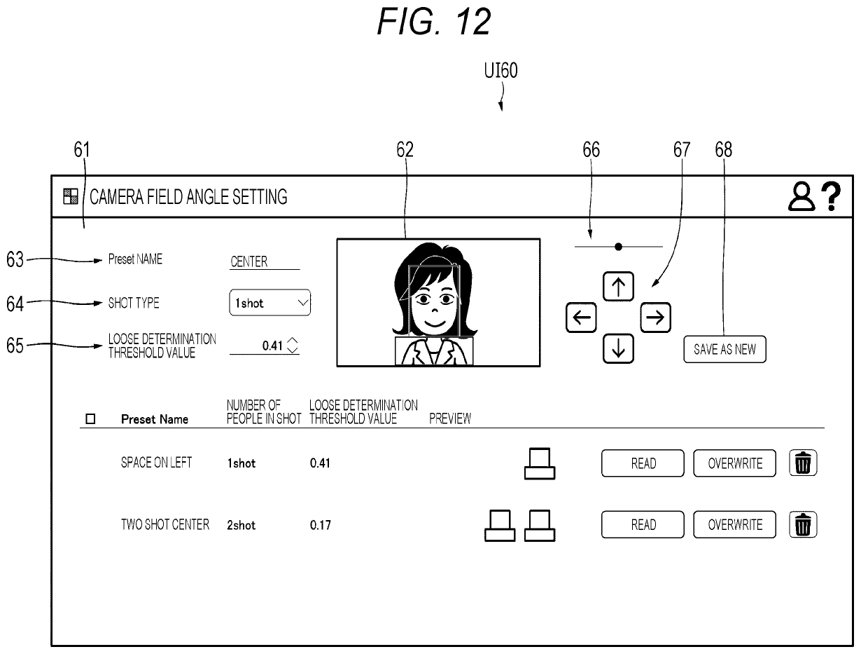

In step ST33, the learning model generated by the learning unit 33A is displayed on a UI. For example, the generated learning model is displayed on the UI of the automatic shooting controller 3. FIG. 12 is a view showing an example of a UI (a UI 60) in which a learning model is displayed. The UI 60 includes a display part 61. Near a center of the display part 61, a learning model (in the present embodiment, a field angle) 62 obtained as a result of learning is displayed.

In storing the generated learning model as a preset, the UI 60 can be used to set a preset name and the like of the learning model. For example, the UI 60 has “preset name” as an item 63 and a “shot type” as an item 64. In the illustrated example, “center” is set as the “preset name” and “1 shot” is set as the “shot type”.

The learning model generated as a result of learning is used in the threshold value determination processing of the threshold value determination processing unit 34. Therefore, in the present embodiment, the UI 60 includes “loose determination threshold value” as an item 65, which enables setting of a threshold value for determining whether or not the field angle is appropriate. By enabling setting of the threshold value, for example, it becomes possible for a camera operator to set how much deviation in the field angle is allowed. In the illustrated example, “0.41” is set as “loose determination threshold value”. Moreover, a field angle corresponding to the learning model can be adjusted by using a zoom adjustment part 66 and a position adjustment part 67 including the cross key. The learning model with various kinds of setting is stored, for example, by pressing a button 68 displayed as “save as new”. Note that, in a case where a learning model of a similar scene has been generated in the past, the newly generated learning model may be overwritten and saved on the learning model generated in the past.

In the example shown in FIG. 12, two learning models that have already been obtained are displayed. The first learning model is a learning model corresponding to a field angle of a one shot having a space on left, and is a learning model in which 0.41 is set as a loose determination threshold value. The second learning model is a learning model corresponding to a field angle of a center in a two shot, and is a learning model in which 0.17 is set as a loose determination threshold value. In this way, the learning model is stored for each of scenes.

Note that, in the example described above, for example, shooting may be stopped by pressing the shooting start button 53A again, for example. Furthermore, the process related to the learning phase may be ended by pressing the learn button 53B again. Furthermore, shooting and learning may be ended at the same time by pressing the shooting start button 53A again. As described above, a trigger for a shooting start, a trigger for a learning start, a trigger for a shooting end, and a trigger for a learning end may be independent operations. In this case, the shooting start button 53A may be pressed once and the learn button 53B may be pressed during shooting after the shooting start, and the process related to the learning phase may be performed at a predetermined timing during on-air (at a start of on-air, in the middle of on-air, or the like).

Furthermore, in the example described above, two separate buttons are individually used as the shooting start button 53A and the learn button 53B. However, only one button may be used, and such one button may serve as a trigger for a shooting start and a trigger for a learning start. That is, the trigger for a shooting start and the trigger for a learning start may be common operations. Specifically, by pressing one button, a shooting start may be instructed, and learning by the learning unit 33A in parallel with the shooting may be performed on the basis of an image (in the present embodiment, a feature image) obtained by shooting. It is also possible to perform a process for determining whether or not a field angle of an image obtained by shooting is appropriate. In other words, the process in the control phase and the process in the learning phase may be performed in parallel. Note that, in this case, by pressing the one button described above, the shooting may be stopped and also the process related to the learning phase may be ended. That is, the trigger for a shooting end and the trigger for a learning end may be common operations.

Furthermore, as in the example described above, in an example in which two buttons are provided such as the shooting start button 53A and the learn button 53B, that is, in a case where the trigger for a shooting start and the trigger for a learning start are performed with independent operations, one button may be provided to end the shooting and the process in the learning phase with one operation. That is, the trigger for a shooting start and the trigger for a learning start may be different operations, and the trigger for a shooting end and the trigger for a learning end may be common operations.

For example, an end of the shooting or the process in the learning phase may be triggered by an operation other than pressing the button again. For example, the shooting and the processes in the learning phase may be ended at the same time when the shooting (on-air) is ended. For example, the process in the learning phase may be automatically ended when there is no input of a tally signal indicating that shooting is in progress. Furthermore, a start of the process in the learning phase may also be triggered by the input of the tally signal.

The embodiment of the present disclosure has been described above.

According to the embodiment, for example, a trigger for a learning start (a trigger for shifting to the learning phase) can be inputted at any timing when the user desires to acquire teacher data. Furthermore, since the learning is performed on the basis of only at least a part of correct answer images acquired in response to the trigger for a learning start, the learning cost can be reduced. Furthermore, in a case of studio shooting or the like, incorrect answer images are not usually shot. However, in the embodiment, since incorrect answer images are not used during learning, it is not necessary to acquire the incorrect answer images.

Furthermore, in the embodiment, the learning model obtained as a result of learning is used to determine whether a field angle is appropriate. Then, in a case where the field angle is inappropriate, an image segmentation position is automatically corrected. Therefore, it is not necessary for a camera operator to operate the imaging device to acquire an image having an appropriate field angle, and it is possible to automate a series of operations in shooting that have been performed manually.

<Modification>

Although the embodiment of the present disclosure has been specifically described above, the contents of the present disclosure are not limited to the embodiment described above, and various modifications based on the technical idea of the present disclosure are possible. Hereinafter, modifications will be described.

[First Modification]

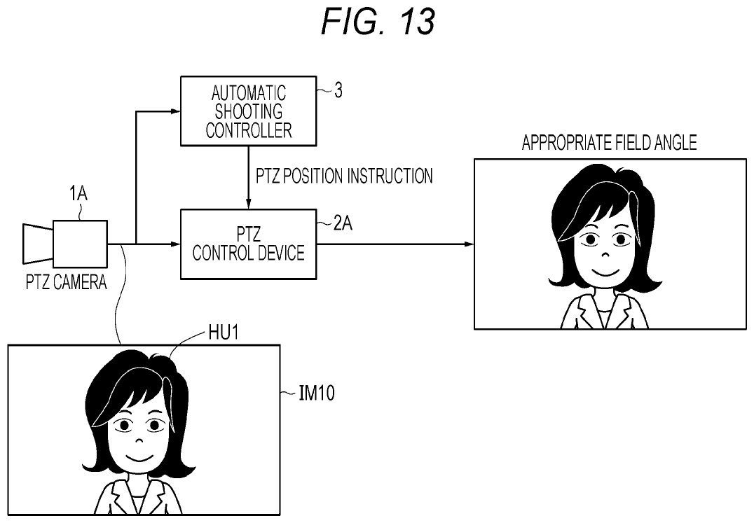

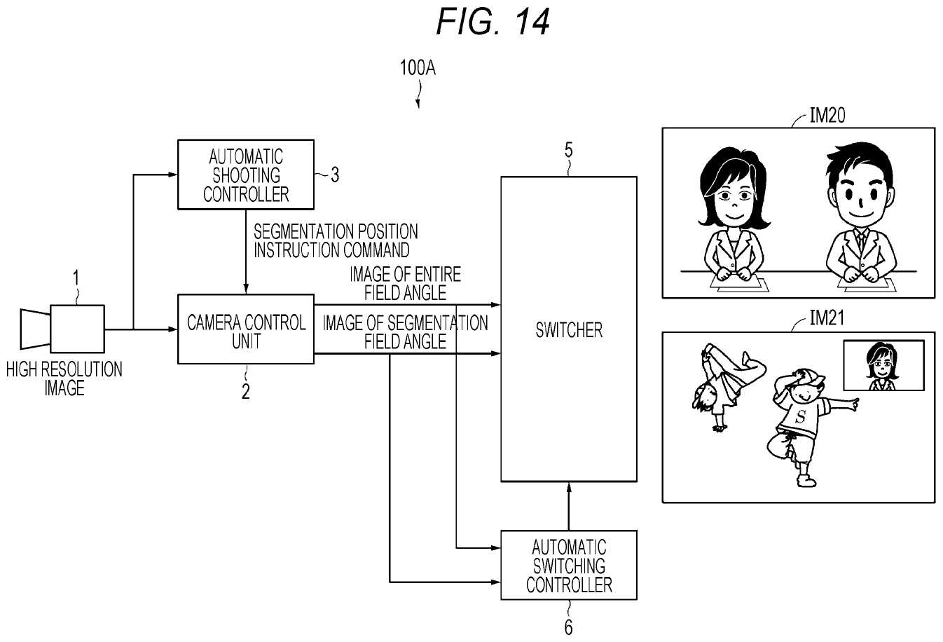

FIG. 13 is a diagram for explaining a first modification. The first modification is different from the embodiment in that the imaging device 1 is a PTZ camera 1A, and the camera control unit 2 is a PTZ control device 2A. The PTZ camera 1A is a camera in which pan (an abbreviation of panoramic view), control of tilt, and control of zoom can be made by remote control. Pan is control of moving a field angle of the camera in a horizontal direction (swinging in the horizontal direction), tilt is control of moving the field angle of the camera in a vertical direction (swinging in the vertical direction), and zoom is control of enlarging and reducing the field angle to display. The PTZ control device 2A controls the PTZ camera 1A in response to a PTZ position instruction command supplied from the automatic shooting controller 3.

A process performed in the first modification will be described. An image acquired by the PTZ camera 1A is supplied to the automatic shooting controller 3. As described in the embodiment, the automatic shooting controller 3 uses a learning model obtained by learning, to determine whether or not a field angle of the supplied image is appropriate. In a case where the field angle of the image is inappropriate, a command indicating a PTZ position for achieving an appropriate field angle is outputted to the PTZ control device 2A. The PTZ control device 2A appropriately drives the PTZ camera 1A in response to the PTZ position instruction command supplied from the automatic shooting controller 3.

For example, consider an example in which a female HU1 is shown with an appropriate field angle in an image IM10 as shown in FIG. 13. Suppose that the female HU1 moves upward, such as when she stands up. Since the field angle is deviated from the appropriate field angle due to the movement of the female HU1, the automatic shooting controller 3 generates a PTZ position instruction command for achieving an appropriate field angle. In response to the PTZ position instruction command, the PTZ control device 2A drives, for example, the PTZ camera 1A in a tilt direction. By such control, an image having an appropriate field angle can be obtained. In this way, in order to obtain an image with an appropriate field angle, a PTZ position instruction (an instruction regarding at least one of pan, tilt, or zoom) may be outputted from the automatic shooting controller 3 instead of an image segmentation position.

[Second Modification]

FIG. 14 is a diagram for explaining a second modification. An information processing system (an information processing system 100A) according to the second modification has a switcher 5 and an automatic switching controller 6 in addition to the imaging device 1, the camera control unit 2, and the automatic shooting controller 3. Operations of the imaging device 1, the camera control unit 2, and the automatic shooting controller 3 are similar to the operations described in the embodiment described above. The automatic shooting controller 3 determines whether or not a field angle is appropriate for each of scenes, and outputs a segmentation position instruction command to the camera control unit 2 as appropriate in accordance with a result. The camera control unit 2 outputs an image having an appropriate field angle for each of scenes. A plurality of outputs from the camera control unit 2 is supplied to the switcher 5. The switcher 5 selects and outputs a predetermined image from the plurality of images supplied from the camera control unit 2, in accordance with control of the automatic switching controller 6. For example, the switcher 5 selects and outputs a predetermined image from the plurality of images supplied from the camera control unit 2, in response to a switching command supplied from the automatic switching controller 6.

Examples of a condition for outputting the switching command for switching the image by the automatic switching controller 6 include conditions exemplified below.

For example, the automatic switching controller 6 outputs the switching command so as to randomly switch a scene such as a one shot or a two shot at predetermined time intervals (for example, every 10 seconds).

The automatic switching controller 6 outputs the switching command in accordance with a broadcast content. For example, in a mode in which performers talk, a switching command for selecting an image with the entire field angle is outputted, and the selected image (for example, an image IM20 shown in FIG. 14) is outputted from the switcher 5. Furthermore, for example, when a VTR is broadcast, a switching command for selecting an image segmented at a predetermined position is outputted, and the selected image is used in Picture In Picture (PinP) as shown in an image IM21 shown in FIG. 14. A timing at which the broadcast content is switched to the VTR is inputted to the automatic switching controller 6 by an appropriate method. Note that, in the PinP mode, one shot images with different people may be continuously switched. Furthermore, in a mode of broadcasting performers, the image may be switched so that an image captured from a distance (a whole image) and a one shot image are not continuous.

Furthermore, the automatic switching controller 6 may output a switching command for selecting an image having a lowest evaluation value calculated by the automatic shooting controller 3, that is, an image having a small error and having a more appropriate field angle.

Furthermore, a speaker may be recognized by a known method, and the automatic switching controller 6 may output a switching command for switching to an image of a shot including the speaker.

Note that, in FIG. 14, two pieces of image data are outputted from the camera control unit 2, but more pieces of image data may be outputted.

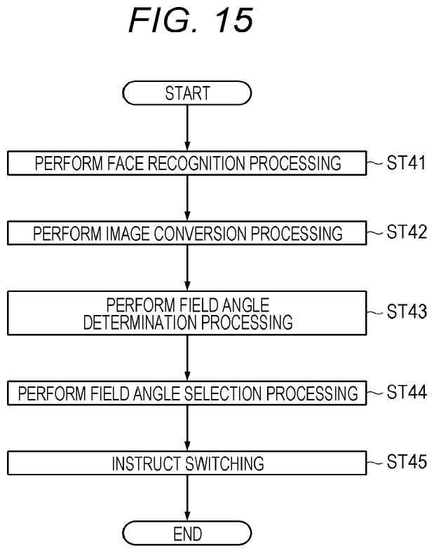

FIG. 15 is a flowchart showing a flow of a process performed by the automatic shooting controller 3 in the second modification. In step ST41, face recognition processing is performed by the face recognition processing unit 32. Then, the process proceeds to step ST42.

In step ST42, the face recognition processing unit 32 performs image conversion processing to generate a feature image such as a binarized image. Then, the process proceeds to step ST43.

In step ST43, it is determined whether or not a field angle of the image is appropriate in accordance with the process performed by the field angle determination processing unit 33B and the threshold value determination processing unit 34. The processes of steps ST41 to ST43 are the same as the processes described in the embodiment. Then, the process proceeds to step ST44.

In step ST44, the automatic switching controller 6 performs field angle selection processing for selecting an image having a predetermined field angle. A condition and a field angle of the image to be selected are as described above. Then, the process proceeds to step ST45.

In step ST45, the automatic switching controller 6 generates a switching command for selecting an image with a field angle determined in the process of step ST44, and outputs the generated switching command to the switcher 5. The switcher 5 selects an image with the field angle specified by the switching command.

[Other Modifications]

Other modifications will be described. The machine learning performed by the automatic shooting controller 3 is not limited to the autoencoder, and may be another method.

In a case where the process in the control phase and the process in the learning phase are performed in parallel, an image determined to have an inappropriate field angle by the process in the control phase may not be used as teacher data in the learning phase, or may be discarded. Furthermore, a threshold value for determining the appropriateness of the field angle may be changed. The threshold value may be changed low for a tighter evaluation or high for a looser evaluation. The threshold value may be changed on a UI screen, and a change of the threshold value may be alerted and notified on the UI screen.

The feature included in the image is not limited to the face region. For example, the feature may be a posture of a person included in the image. In this case, the face recognition processing unit is replaced with a posture detection unit that performs posture detection processing for detecting the posture. As the posture detection processing, a known method can be applied. For example, a method of detecting a feature point in an image and detecting a posture on the basis of the detected feature point can be applied. Examples of the feature point include a feature point based on convolutional neural network (CNN), a histograms of oriented gradients (HOG) feature point, and a feature point based on scale invariant feature transform (SIFT). Then, a portion of the feature point may be set to, for example, a predetermined pixel level including a directional component, and a feature image distinguished from a portion other than the feature point may be generated.

A predetermined input (the shooting start button 53A and the learn button 53B in the embodiment) is not limited to touching or clicking on a screen, and may be an operation on a physical button or the like, or may be a voice input or a gesture input. Furthermore, the predetermined input may be an automatic input performed by a device instead of a human-based input.

In the embodiment, a description has been given to an example in which image data acquired by the imaging device 1 is supplied to each of the camera control unit 2 and the automatic shooting controller 3, but the present invention is not limited to this. For example, image data acquired by the imaging device 1 may be supplied to the camera control unit 2, and image data subjected to predetermined signal processing by the camera control unit 2 may be supplied to the automatic shooting controller 3.

The data acquired in response to the predetermined input may be voice data instead of image data. For example, an agent such as a smart speaker may perform learning on the basis of voice data acquired after the predetermined input is made. Note that the learning unit 33A may be responsible for some functions of the agent.

The information processing apparatus may be an image editing device. In this case, learning is performed in accordance with an input for instructing a learning start, on the basis of image data acquired in response to a predetermined input (for example, an input for instructing a start of editing). At this time, the predetermined input can be an input (a trigger) by pressing an edit button, and the input for instructing the learning start can be an input (a trigger) by pressing the learn button.

A trigger for an editing start, a trigger for a learning start, a trigger for an editing end, and a trigger for a learning end may be independent of each other. For example, when an input of pressing an edit start button is made, editing processing by the processing unit is started, and a feature image is generated on the basis of image data acquired by the editing. When the learn button is pressed, learning is performed by the learning unit using the generated feature image. Furthermore, the editing may be stopped by pressing the editing start button again. Furthermore, the trigger an editing start, the trigger for a learning start, the trigger for an editing end, and the trigger for a learning end may be common. For example, the edit button and the learn button may be provided as one button, and editing may be ended and the process related to the learning phase may be ended by pressing the one button.

Furthermore, in addition to the trigger for a learning start by the user's operation as described above, for example, the editing start may be triggered by an instruction to start up an editing device (starting up an editing application) or an instruction to import editing data (video data) to the editing device.

A configuration of the information processing system according to the embodiment and the modifications can be changed as appropriate. For example, the imaging device 1 may be a device in which the imaging device 1 and at least one configuration of the camera control unit 2 or the automatic shooting controller 3 are integrated. Furthermore, the camera control unit 2 and the automatic shooting controller 3 may be configured as an integrated device. Furthermore, the automatic shooting controller 3 may have a storage unit that stores teacher data (in the embodiment, a binarized image). Furthermore, the teacher data may be outputted to the camera control unit 2 so that the automatic shooting controller 3 shares the teacher data stored in the camera control unit 2 and the automatic shooting controller 3.

The present disclosure can also be realized by an apparatus, a method, a program, a system, and the like. For example, by enabling downloading and installing of a program that performs the functions described in the above embodiment, and downloading and installing the program by an apparatus that does not have the functions described in the embodiment, the control described in the embodiment can be performed in the apparatus. The present disclosure can also be realized by a server that distributes such a program. Furthermore, the items described in the embodiment and the modifications can be appropriately combined.

Note that the contents of the present disclosure are not to be construed as being limited by the effects exemplified in the present disclosure.

The present disclosure may have the following configurations.

(1)

An information processing apparatus having a learning unit configured to acquire data, extract, from the data, data in at least a partial range in accordance with a predetermined input, and perform learning on the basis of the data in at least a partial range.

(2)

The information processing apparatus according to (1), in which

the data is data based on image data corresponding to an image acquired during shooting.

(3)

The information processing apparatus according to (1) or (2), in which

the predetermined input is an input indicating a learning start point.

(4)

The information processing apparatus according to (3), in which

the predetermined input is further an input indicating a learning end point.

(5)

The information processing apparatus according to (4), in which

the learning unit extracts data in a range from the learning start point to the learning end point.

(6)

The information processing apparatus according to any one of (2) to (5), further including:

a learning target image data generation unit configured to perform predetermined processing on the image data, and generate a learning target image data obtained by reconstructing the image data on the basis of a result of the predetermined processing, in which

the learning unit performs learning on the basis of the learning target image data.

(7)

The information processing apparatus according to (6), in which

the learning target image data is image data in which a feature detected by the predetermined processing is symbolized.

(8)

The information processing apparatus according to (6), in which

the predetermined processing is face recognition processing, and the learning target image data is image data in which a face region obtained by the face recognition processing is distinguished from other regions.

(9)

The information processing apparatus according to (6), in which

the predetermined processing is posture detection processing, and the learning target image data is image data in which a feature point region obtained by the posture detection processing is distinguished from other regions.

(10)

The information processing apparatus according to any one of (1) to (9), in which

a learning model based on a result of the learning is displayed.

(11)

The information processing apparatus according to any one of (1) to (10), in which

the learning unit learns a correspondence between scenes and at least one of a shooting condition or an editing condition, for each of the scenes.

(12)

The information processing apparatus according to (11), in which

the scene is a scene specified by a user.

(13)

The information processing apparatus according to (11), in which

the scene is a positional relationship of a person with respect to a field angle.

(14)

The information processing apparatus according to (11), in which

the shooting condition is a condition that may be adjusted during shooting.

(15)

The information processing apparatus according to (11), in which

the editing condition is a condition that may be adjusted during shooting or a recording check.

(16)

The information processing apparatus according to (11), in which

a learning result obtained by the learning unit is stored for each of the scenes.

(17)

The information processing apparatus according to (16), in which

the learning result is stored in a server device capable of communicating with the information processing apparatus.

(18)

The information processing apparatus according to (16), further including:

a determination unit configured to make a determination using the learning result.

(19)

The information processing apparatus according to any one of (2) to (19), further including:

an input unit configured to accept the predetermined input; and

an imaging unit configured to acquire the image data.

(20)

An information processing method including: acquiring data; extracting, from the data, data in at least a partial range in accordance with a predetermined input; and performing learning, by a learning unit, on the basis of the data in at least a partial range.

(21)

A program for causing a computer to execute an information processing method including: acquiring data; extracting, from the data, data in at least a partial range in accordance with a predetermined input; and performing learning, by a learning unit, on the basis of the data in at least a partial range. <Application Example>

The technology according to the present disclosure can be applied to various products. For example, the technology according to the present disclosure may be applied to an operating room system.

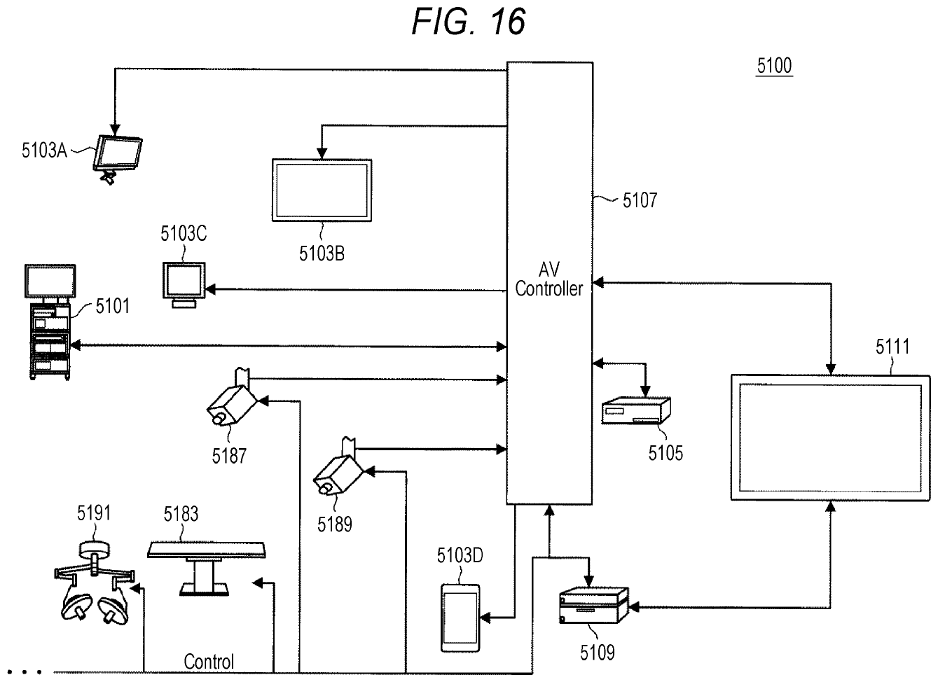

FIG. 16 is a diagram schematically showing an overall configuration of an operating room system 5100 to which the technology according to the present disclosure can be applied. Referring to FIG. 16, the operating room system 5100 is configured by connecting a device group installed in the operating room to be able to cooperate with each other via an audiovisual controller (AV controller) 5107 and an operating room control device 5109.

In the operating room, various devices may be installed. FIG. 16 illustrates, as an example, a device group 5101 of various types for endoscopic surgery, a ceiling camera 5187 provided on a ceiling of the operating room to image an operator's hand, an operation-place camera 5189 provided on the ceiling of the operating room to image a state of the entire operating room, a plurality of display devices 5103A to 5103D, a recorder 5105, a patient bed 5183, and an illumination lamp 5191.

Here, among these devices, the device group 5101 belongs to an endoscopic surgery system 5113 as described later, and includes an endoscope and a display device or the like that displays an image captured by the endoscope. Each device belonging to the endoscopic surgery system 5113 is also referred to as a medical device. Whereas, the display devices 5103A to 5103D, the recorder 5105, the patient bed 5183, and the illumination lamp 5191 are devices provided separately from the endoscopic surgery system 5113, for example, in the operating room. Each of the devices that do not belong to the endoscopic surgery system 5113 is also referred to as a non-medical device. The audiovisual controller 5107 and/or the operating room control device 5109 control action of these medical devices and non-medical devices in cooperation with each other.

The audiovisual controller 5107 integrally controls processing related to image display in the medical devices and the non-medical devices. Specifically, among the devices included in the operating room system 5100, the device group 5101, the ceiling camera 5187, and the operation-place camera 5189 may be devices (hereinafter, also referred to as transmission source devices) having a function of transmitting information (hereinafter, also referred to as display information) to be displayed during the surgery. Furthermore, the display devices 5103A to 5103D may be devices to which display information is outputted (hereinafter, also referred to as output destination devices). Furthermore, the recorder 5105 may be a device corresponding to both the transmission source device and the output destination device. The audiovisual controller 5107 has a function of controlling action of the transmission source device and the output destination device, acquiring display information from the transmission source device, transmitting the display information to the output destination device, and controlling to display and record the display information. Note that the display information is various images captured during the surgery, various types of information regarding the surgery (for example, physical information of the patient, information regarding a past examination result, an operative procedure, and the like), and the like.

Specifically, from the device group 5101 to the audiovisual controller 5107, as the display information, information may be transmitted regarding an image of an operative site in the patient's body cavity imaged by the endoscope. Furthermore, from the ceiling camera 5187, as display information, information regarding an image of the operator's hand imaged by the ceiling camera 5187 may be transmitted. Furthermore, from the operation-place camera 5189, as display information, information regarding an image indicating a state of the entire operating room imaged by the operation-place camera 5189 may be transmitted. Note that, in a case where there is another device having an imaging function in the operating room system 5100, the audiovisual controller 5107 may also acquire information regarding an image captured by the other device as the display information also from the other device.

Alternatively, for example, in the recorder 5105, information about these images captured in the past is recorded by the audiovisual controller 5107. The audiovisual controller 5107 can acquire information regarding the image captured in the past from the recorder 5105, as display information. Note that the recorder 5105 may also record various types of information regarding the surgery in advance.

The audiovisual controller 5107 causes at least any of the display devices 5103A to 5103D, which are output destination devices, to display the acquired display information (in other words, an image shot during the surgery and various types of information regarding the surgery). In the illustrated example, the display device 5103A is a display device installed to be suspended from the ceiling of the operating room, the display device 5103B is a display device installed on a wall of the operating room, the display device 5103C is a display device installed on a desk in the operating room, and the display device 5103D is a mobile device (for example, a tablet personal computer (PC)) having a display function.

Furthermore, although illustration is omitted in FIG. 16, the operating room system 5100 may include an apparatus external to the operating room. The apparatus external to the operating room may be, for example, a server connected to a network constructed inside or outside a hospital, a PC to be used by medical staff, a projector installed in a conference room of the hospital, or the like. In a case where such an external device is present outside the hospital, the audiovisual controller 5107 can also causes a display device of another hospital to display the display information, via a video conference system or the like, for telemedicine.

The operating room control device 5109 integrally controls processing other than the processing related to the image display in the non-medical device. For example, the operating room control device 5109 controls driving of the patient bed 5183, the ceiling camera 5187, the operation-place camera 5189, and the illumination lamp 5191.

The operating room system 5100 is provided with a centralized operation panel 5111, and, via the centralized operation panel 5111, the user can give instructions regarding the image display to the audiovisual controller 5107 and give instructions regarding action of the non-medical device to the operating room control device 5109. The centralized operation panel 5111 is configured by providing a touch panel on a display surface of the display device.

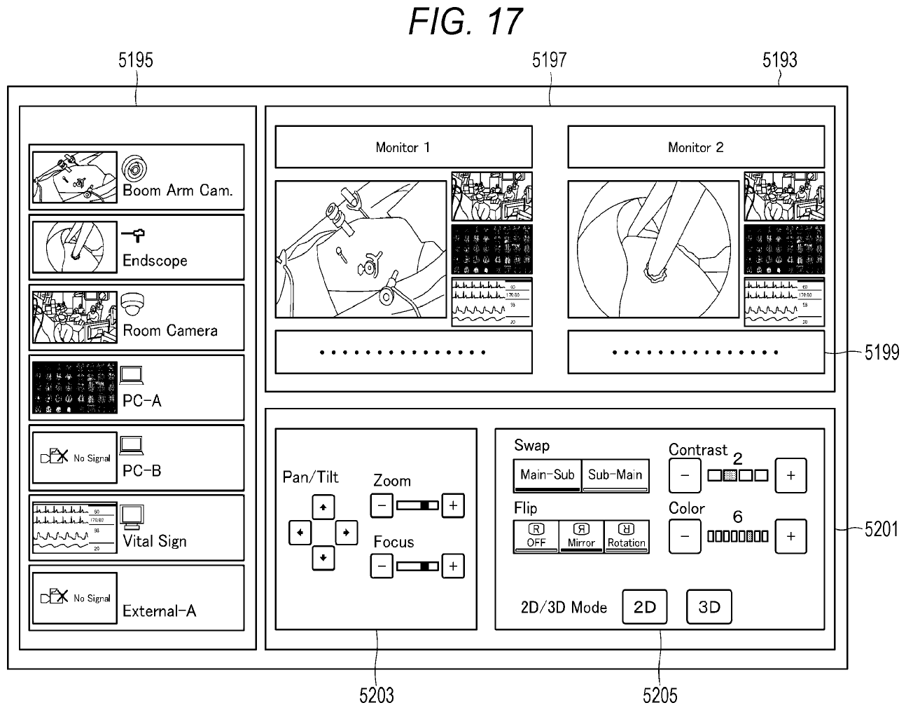

FIG. 17 is a view showing a display example of an operation screen on the centralized operation panel 5111. FIG. 17 shows, as an example, an operation screen corresponding to a case where two display devices are provided as an output destination device in the operating room system 5100. Referring to FIG. 17, an operation screen 5193 is provided with a transmission source selection area 5195, a preview area 5197, and a control area 5201.

In the transmission source selection area 5195, transmission source devices provided in the operating room system 5100 and thumbnail screens showing display information of the transmission source devices are displayed in association with each other. The user can select display information desired to be displayed on the display device from any of the transmission source devices displayed in the transmission source selection area 5195.

In the preview area 5197, preview of screens displayed on two display devices (Monitor 1 and Monitor 2), which are output destination devices, is displayed. In the illustrated example, four images are displayed in PinP on one display device. The four images correspond to the display information transmitted from the transmission source device selected in the transmission source selection area 5195. Among the four images, one is displayed relatively large as a main image, and the remaining three are displayed relatively small as sub images. The user can replace the main image with the sub image by appropriately selecting the region where the four images are displayed. Furthermore, in a lower part of the area where four images are displayed, a status display area 5199 is provided, and a status regarding the surgery (for example, an elapsed time of the surgery, physical information of the patient, and the like) can be appropriately displayed in the area.

The control area 5201 is provided with: a transmission source operation area 5203 in which a graphical user interface (GUI) component for performing an operation on a transmission source device is displayed; and an output destination operation area 5205 in which a GUI component for performing an operation on an output destination device is displayed. In the illustrated example, the transmission source operation area 5203 is provided with a GUI component for performing various operations (pan, tilt, and zoom) on a camera in the transmission source device having an imaging function. The user can operate action of the camera in the transmission source device by appropriately selecting these GUI components. Note that, although illustration is omitted, in a case where the transmission source device selected in the transmission source selection area 5195 is a recorder (in other words, in a case where an image recorded in the past on the recorder is displayed in the preview area 5197), the transmission source operation area 5203 may be provided with a GUI component for performing operations such as reproduction, reproduction stop, rewind, and fast forward of the image.

Furthermore, the output destination operation area 5205 is provided with a GUI component for performing various operations (swap, flip, color adjustment, contrast adjustment, switching of 2D display and 3D display) on display on the display device, which is the output destination device. The user can operate display on the display device, by appropriately selecting these GUI components.

Note that the operation screen displayed on the centralized operation panel 5111 is not limited to the illustrated example, and the user may be able to perform, via the centralized operation panel 5111, operation input to each device that may be controlled by the audiovisual controller 5107 and the operating room control device 5109, provided in the operating room system 5100.

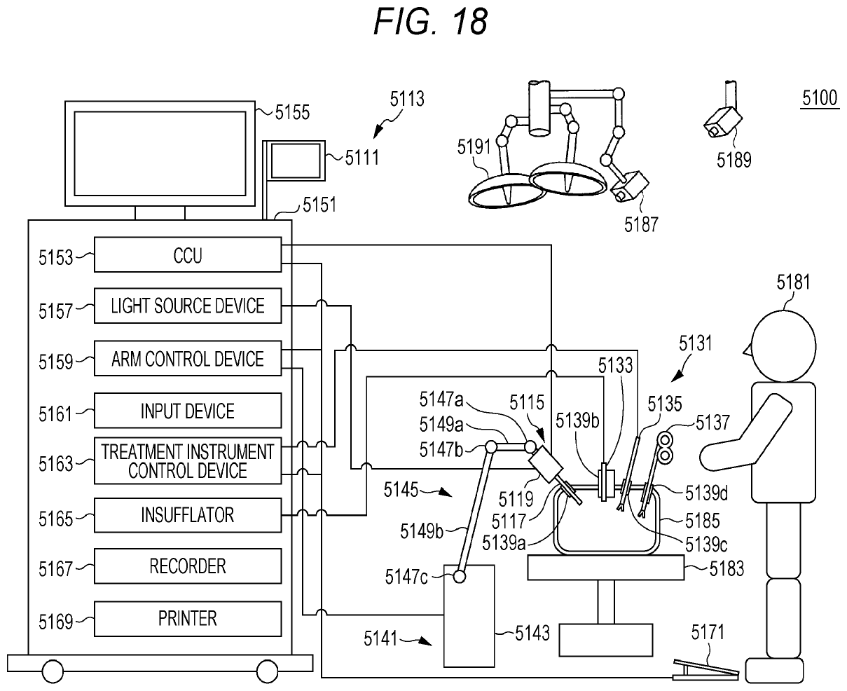

FIG. 18 is a diagram showing an example of a state of operation to which the operating room system is applied as described above. The ceiling camera 5187 and the operation-place camera 5189 are provided on the ceiling of the operating room, and can image a hand of an operator (surgeon) 5181 who performs treatment on an affected area of a patient 5185 on the patient bed 5183 and a state of the entire operating room. The ceiling camera 5187 and the operation-place camera 5189 may be provided with a magnification adjustment function, a focal length adjustment function, a shooting direction adjustment function, and the like. The illumination lamp 5191 is provided on the ceiling of the operating room and illuminates at least the hand of the operator 5181. The illumination lamp 5191 may be capable of appropriately adjusting an irradiation light amount thereof, a wavelength (color) of the irradiation light, an irradiation direction of the light, and the like.

The endoscopic surgery system 5113, the patient bed 5183, the ceiling camera 5187, the operation-place camera 5189, and the illumination lamp 5191 are connected, as shown in FIG. 16, so as to be able to cooperate with each other via the audiovisual controller 5107 and the operating room control device 5109 (not shown in FIG. 18). The centralized operation panel 5111 is provided in the operating room, and as described above, the user can appropriately operate these devices present in the operating room via the centralized operation panel 5111.

Hereinafter, a configuration of the endoscopic surgery system 5113 will be described in detail. As illustrated, the endoscopic surgery system 5113 includes: an endoscope 5115; other surgical instrument 5131; a support arm device 5141 supporting the endoscope 5115; and a cart 5151 mounted with various devices for endoscopic surgery.

In endoscopic surgery, instead of cutting and opening the abdominal wall, a plurality of cylindrical opening tools called trocars 5139a to 5139d is punctured in the abdominal wall. Then, from the trocars 5139a to 5139d, a lens barrel 5117 of the endoscope 5115 and other surgical instrument 5131 are inserted into the body cavity of the patient 5185. In the illustrated example, as other surgical instrument 5131, an insufflation tube 5133, an energy treatment instrument 5135, and forceps 5137 are inserted into the body cavity of the patient 5185. Furthermore, the energy treatment instrument 5135 is a treatment instrument that performs incision and peeling of a tissue, sealing of a blood vessel, or the like by a high-frequency current or ultrasonic vibrations. However, the illustrated surgical instrument 5131 is merely an example, and various surgical instruments generally used in endoscopic surgery, for example, tweezers, retractor, and the like may be used as the surgical instrument 5131.

An image of the operative site in the body cavity of the patient 5185 shot by the endoscope 5115 is displayed on a display device 5155. While viewing the image of the operative site displayed on the display device 5155 in real time, the operator 5181 uses the energy treatment instrument 5135 or the forceps 5137 to perform treatment such as, for example, removing the affected area, or the like. Note that, although illustration is omitted, the insufflation tube 5133, the energy treatment instrument 5135, and the forceps 5137 are held by the operator 5181, an assistant, or the like during the surgery.

(Support Arm Device)

The support arm device 5141 includes an arm unit 5145 extending from a base unit 5143. In the illustrated example, the arm unit 5145 includes joint units 5147a, 5147b, and 5147c, and links 5149a and 5149b, and is driven by control from an arm control device 5159. The arm unit 5145 supports the endoscope 5115, and controls a position and an orientation thereof. With this arrangement, stable position fixation of the endoscope 5115 can be realized.

(Endoscope)

The endoscope 5115 includes the lens barrel 5117 whose region of a predetermined length from a distal end is inserted into the body cavity of the patient 5185, and a camera head 5119 connected to a proximal end of the lens barrel 5117. In the illustrated example, the endoscope 5115 configured as a so-called rigid scope having a rigid lens barrel 5117 is illustrated, but the endoscope 5115 may be configured as a so-called flexible endoscope having a flexible lens barrel 5117.

At the distal end of the lens barrel 5117, an opening fitted with an objective lens is provided. The endoscope 5115 is connected with a light source device 5157, and light generated by the light source device 5157 is guided to the distal end of the lens barrel by a light guide extended inside the lens barrel 5117, and emitted toward an observation target in the body cavity of the patient 5185 through the objective lens. Note that the endoscope 5115 may be a forward-viewing endoscope, or may be an oblique-viewing endoscope or a side-viewing endoscope.

Inside the camera head 5119, an optical system and an imaging element are provided, and reflected light (observation light) from the observation target is condensed on the imaging element by the optical system. The observation light is photoelectrically converted by the imaging element, and an electric signal corresponding to the observation light, in other words, an image signal corresponding to an observation image is generated. The image signal is transmitted to a camera control unit (CCU) 5153 as RAW data. Note that the camera head 5119 is installed with a function of adjusting a magnification and a focal length by appropriately driving the optical system.

Note that, for example, in order to support stereoscopic vision (3D display) or the like, a plurality of imaging elements may be provided in the camera head 5119. In this case, inside the lens barrel 5117, a plurality of relay optical systems is provided in order to guide observation light to each of the plurality of imaging elements.

(Various Devices Installed in Cart)

The CCU 5153 is configured by a central processing unit (CPU), a graphics processing unit (GPU), and the like, and integrally controls action of the endoscope 5115 and the display device 5155. Specifically, the CCU 5153 applies, on the image signal received from the camera head 5119, various types of image processing for displaying an image on the basis of the image signal, for example, development processing (demosaicing processing) and the like. The CCU 5153 supplies the image signal subjected to the image processing to the display device 5155. Furthermore, the CCU 5153 is connected with the audiovisual controller 5107 shown in FIG. 16. The CCU 5153 also supplies the image signal subjected to the image processing to the audiovisual controller 5107. Furthermore, the CCU 5153 transmits a control signal to the camera head 5119 to control the driving thereof. The control signal may include information regarding imaging conditions such as a magnification and a focal length. The information regarding the imaging conditions may be inputted through an input device 5161, or may be inputted through the above-described centralized operation panel 5111.

The display device 5155 displays an image on the basis of the image signal subjected to the image processing by the CCU 5153, under the control of the CCU 5153. In a case where the endoscope 5115 supports high-resolution imaging such as, for example, 4K (number of horizontal pixels 3840×number of vertical pixels 2160), 8K (number of horizontal pixels 7680×number of vertical pixels 4320), or the like and/or supports a 3D display, one capable of high resolution display and/or one capable of 3D display corresponding respectively, may be used as the display device 5155. In a case where the endoscope 5115 supports high resolution imaging such as 4K or 8K, a sense of immersion can be further obtained by using a display device 5155 having a size of 55 inches or more. Furthermore, a plurality of the display devices 5155 having different resolutions and sizes may be provided depending on the application.

The light source device 5157 is configured by a light source such as a light emitting diode (LED), for example, and supplies irradiation light at a time of imaging the operative site to the endoscope 5115.

The arm control device 5159 is configured by a processor such as a CPU, for example, and controls driving of the arm unit 5145 of the support arm device 5141 in accordance with a predetermined control method, by acting in accordance with a predetermined program.

The input device 5161 is an input interface to the endoscopic surgery system 5113. The user can input various types of information and input instructions to the endoscopic surgery system 5113 via the input device 5161. For example, the user inputs, via the input device 5161, various types of information regarding the surgery such as physical information of the patient and information regarding an operative procedure. Furthermore, for example, via the input device 5161, the user inputs an instruction for driving the arm unit 5145, an instruction for changing imaging conditions (a type of irradiation light, a magnification, a focal length, and the like) by the endoscope 5115, an instruction for driving the energy treatment instrument 5135, and the like.

A type of the input device 5161 is not limited, and the input device 5161 may be various known input devices. For example, a mouse, a keyboard, a touch panel, a switch, a foot switch 5171, and/or a lever, and the like may be applied as the input device 5161. In a case where a touch panel is used as the input device 5161, the touch panel may be provided on a display surface of the display device 5155.

Alternatively, the input device 5161 is a device worn by the user, for example, a glasses type wearable device or a head mounted display (HMD) and the like, and various inputs are performed in accordance with a user's gesture or line-of-sight detected by these devices. Furthermore, the input device 5161 includes a camera capable of detecting user's movement, and various inputs are performed in accordance with a user's gesture and line-of-sight detected from an image captured by the camera. Moreover, the input device 5161 includes a microphone capable of collecting user's voice, and various inputs are performed by voice via the microphone. As described above, by configuring the input device 5161 to be able to input various types of information in a non-contact manner, a user (for example, the operator 5181) particularly belonging to a clean region can operate a device belonging to an unclean region without contacting. Furthermore, since the user can operate the device without releasing his/her hand from the surgical instrument being held, the convenience of the user is improved.

A treatment instrument control device 5163 controls driving of the energy treatment instrument 5135 for ablation of a tissue, incision, sealing of a blood vessel, or the like. An insufflator 5165 sends gas into the body cavity through the insufflation tube 5133 in order to inflate the body cavity of the patient 5185 for the purpose of securing a visual field by the endoscope 5115 and securing a working space of the operator. A recorder 5167 is a device capable of recording various types of information regarding the surgery. A printer 5169 is a device capable of printing various types of information regarding the surgery in various forms such as text, images, and graphs.

Hereinafter, a particularly characteristic configuration of the endoscopic surgery system 5113 will be described in more detail.

(Support Arm Device)

The support arm device 5141 includes the base unit 5143 that is a base, and the arm unit 5145 extending from the base unit 5143. In the illustrated example, the arm unit 5145 includes a plurality of the joint units 5147a, 5147b, and 5147c, and a plurality of the links 5149a and 5149b connected by the joint unit 5147b, but the configuration of the arm unit 5145 is illustrated in a simplified manner in FIG. 18, for the sake of simplicity. In practice, a shape, the number, and an arrangement of the joint units 5147a to 5147c and the links 5149a and 5149b, a direction of a rotation axis of the joint units 5147a to 5147c, and the like may be set as appropriate such that the arm unit 5145 has a desired degree of freedom. For example, the arm unit 5145 may be preferably configured to have a degree of freedom of six or more degrees of freedom. With this configuration, since the endoscope 5115 can be freely moved within a movable range of the arm unit 5145, it is possible to insert the lens barrel 5117 of the endoscope 5115 into the body cavity of the patient 5185 from a desired direction.

The joint units 5147a to 5147c are provided with an actuator, and the joint units 5147a to 5147c are configured to be rotatable around a predetermined rotation axis by driving of the actuator. By controlling the driving of the actuator with the arm control device 5159, rotation angles of the individual joint units 5147a to 5147c are controlled, and driving of the arm unit 5145 is controlled. With this configuration, control of a position and an orientation of the endoscope 5115 can be realized. At this time, the arm control device 5159 can control the driving of the arm unit 5145 by various known control methods such as force control or position control.

For example, by the operator 5181 appropriately performing operation input via the input device 5161 (including the foot switch 5171), the driving of the arm unit 5145 may be appropriately controlled by the arm control device 5159 in accordance with the operation input, and a position and an orientation of the endoscope 5115 may be controlled. With this control, the endoscope 5115 at the distal end of the arm unit 5145 can be moved from any position to any position, and then fixedly supported at a position after the movement. Note that the arm unit 5145 may be operated by a so-called master slave method. In this case, the arm unit 5145 can be remotely operated by the user via the input device 5161 installed at a location distant from the operating room.

Furthermore, in a case where force control is applied, the arm control device 5159 may perform a so-called power assist control for driving the actuator of the individual joint unit 5147a to 5147c such that the arm unit 5145 receives an external force from the user and moves smoothly in accordance with the external force. Thus, when the user moves the arm unit 5145 while directly touching the arm unit 5145, the arm unit 5145 can be moved with a relatively light force. Therefore, it becomes possible to move the endoscope 5115 more intuitively and with a simpler operation, and the convenience of the user can be improved.

Here, in general, in endoscopic surgery, the endoscope 5115 is held by a doctor called scopist. Whereas, since it becomes possible to fix the position of the endoscope 5115 more reliably without human hands by using the support arm device 5141, an image of the operative site can be stably obtained, and the surgery can be smoothly performed.

Note that the arm control device 5159 may not necessarily be provided in the cart 5151. Furthermore, the arm control device 5159 may not necessarily be one device. For example, the arm control device 5159 may be individually provided at each of the joint units 5147a to 5147c of the arm unit 5145 of the support arm device 5141, and a plurality of the arm control devices 5159 may cooperate with one another to realize drive control of the arm unit 5145.

(Light Source Device)

The light source device 5157 supplies the endoscope 5115 with irradiation light for imaging the operative site. The light source device 5157 includes, for example, a white light source configured by an LED, a laser light source, or a combination thereof. At this time, in a case where the white light source is configured by a combination of RGB laser light sources, since output intensity and output timing of each color (each wavelength) can be controlled with high precision, the light source device 5157 can adjust white balance of a captured image. Furthermore, in this case, it is also possible to capture an image corresponding to each of RGB in a time division manner by irradiating the observation target with laser light from each of the RGB laser light sources in a time-division manner, and controlling driving of the imaging element of the camera head 5119 in synchronization with the irradiation timing. According to this method, it is possible to obtain a color image without providing a color filter in the imaging element.

Furthermore, driving of the light source device 5157 may be controlled to change intensity of the light to be outputted at predetermined time intervals. By acquiring images in a time-division manner by controlling the driving of the imaging element of the camera head 5119 in synchronization with the timing of the change of the light intensity, and combining the images, it is possible to generate an image of a high dynamic range without a so-called black defects and whiteout.

Furthermore, the light source device 5157 may be configured to be able to supply light having a predetermined wavelength band corresponding to special light observation. In the special light observation, for example, so-called narrow band imaging is performed in which predetermined tissues such as blood vessels in a mucous membrane surface layer are imaged with high contrast by utilizing wavelength dependency of light absorption in body tissue and irradiating the predetermined tissues with narrow band light as compared to the irradiation light (in other words, white light) at the time of normal observation. Alternatively, in the special light observation, fluorescence observation for obtaining an image by fluorescence generated by irradiation of excitation light may be performed. In the fluorescence observation, it is possible to perform one that irradiates a body tissue with excitation light and observes fluorescence from the body tissue (autofluorescence observation), one that locally injects a reagent such as indocyanine green (ICG) into a body tissue and irradiates the body tissue with excitation light corresponding to the fluorescence wavelength of the reagent to obtain a fluorescent image, or the like. The light source device 5157 may be configured to be able to supply narrow band light and/or excitation light corresponding to such special light observation.

(Camera Head and CCU)

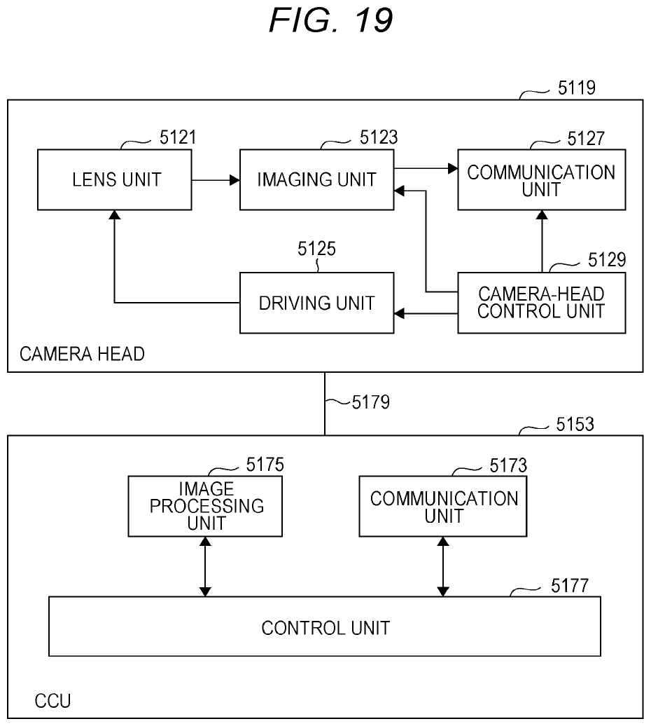

Functions of the camera head 5119 and the CCU 5153 of the endoscope 5115 will be described in more detail with reference to FIG. 19. FIG. 19 is a block diagram showing an example of a functional configuration of the camera head 5119 and the CCU 5153 shown in FIG. 18.

Referring to FIG. 19, the camera head 5119 has a lens unit 5121, an imaging unit 5123, a driving unit 5125, a communication unit 5127, and a camera-head control unit 5129 as functions thereof. Furthermore, the CCU 5153 has a communication unit 5173, an image processing unit 5175, and a control unit 5177 as functions thereof. The camera head 5119 and the CCU 5153 are communicably connected in both directions by a transmission cable 5179.

First, a functional configuration of the camera head 5119 will be described. The lens unit 5121 is an optical system provided at a connection part with the lens barrel 5117. Observation light taken in from the distal end of the lens barrel 5117 is guided to the camera head 5119 and is incident on the lens unit 5121. The lens unit 5121 is configured by combining a plurality of lenses including a zoom lens and a focus lens. The optical characteristic of the lens unit 5121 is adjusted so as to condense the observation light on a light receiving surface of an imaging element of the imaging unit 5123. Furthermore, the zoom lens and the focus lens are configured such that positions thereof on the optical axis can be moved for adjustment of a magnification and focus of a captured image.

The imaging unit 5123 is configured by the imaging element, and is disposed downstream of the lens unit 5121. Observation light having passed through the lens unit 5121 is condensed on the light receiving surface of the imaging element, and an image signal corresponding to an observation image is generated by photoelectric conversion. The image signal generated by the imaging unit 5123 is provided to the communication unit 5127.

As an imaging element that configures the imaging unit 5123, for example, a complementary metal oxide semiconductor (CMOS) type image sensor having a Bayer arrangement and being capable of a color shooting is used. Note that, as the imaging element, for example, one applicable to shooting of a high resolution image of 4K or more may be used. Since an image of the operative site can be obtained with high resolution, the operator 5181 can grasp a state of the operative site in more detail, and can proceed the surgery more smoothly.

Furthermore, the imaging element that configures the imaging unit 5123 has a configuration having a pair of imaging elements for individually acquiring image signals for the right eye and for the left eye corresponding to 3D display. Performing 3D display enables the operator 5181 to more accurately grasp a depth of living tissues in the operative site. Note that, in a case where the imaging unit 5123 is configured as a multi-plate type, a plurality of systems of the lens unit 5121 is also provided corresponding to individual imaging elements.

Furthermore, the imaging unit 5123 may not necessarily be provided in the camera head 5119. For example, the imaging unit 5123 may be provided inside the lens barrel 5117 immediately after the objective lens.

The driving unit 5125 is configured by an actuator, and moves the zoom lens and the focus lens of the lens unit 5121 along the optical axis by a predetermined distance under control from the camera-head control unit 5129. With this configuration, a magnification and focus of a captured image by the imaging unit 5123 may be appropriately adjusted.

The communication unit 5127 is configured by a communication device for exchange of various types of information with the CCU 5153. The communication unit 5127 transmits an image signal obtained from the imaging unit 5123 to the CCU 5153 via the transmission cable 5179 as RAW data. In this case, in order to display a captured image of the operative site with low latency, it is preferable that the image signal is transmitted by optical communication. This is because, since the operator 5181 performs the surgery while observing the condition of the affected area through the captured image during the surgery, it is required that a moving image of the operative site be displayed in real time as much as possible for a safer and more reliable surgery. In a case where optical communication is performed, the communication unit 5127 is provided with a photoelectric conversion module that converts an electrical signal into an optical signal. An image signal is converted into an optical signal by the photoelectric conversion module, and then transmitted to the CCU 5153 via the transmission cable 5179.

Furthermore, the communication unit 5127 receives, from the CCU 5153, a control signal for controlling driving of the camera head 5119. The control signal includes, for example, information regarding imaging conditions such as information of specifying a frame rate of a captured image, information of specifying an exposure value at the time of imaging, information of specifying a magnification and focus of a captured image, and/or the like. The communication unit 5127 provides the received control signal to the camera-head control unit 5129. Note that the control signal from the CCU 5153 may also be transmitted by optical communication. In this case, the communication unit 5127 is provided with a photoelectric conversion module that converts an optical signal into an electrical signal, and a control signal is converted into an electrical signal by the photoelectric conversion module, and then provided to the camera-head control unit 5129.

Note that imaging conditions such as a frame rate, an exposure value, a magnification, and focus described above are automatically set by the control unit 5177 of the CCU 5153 on the basis of the acquired image signal. That is, a so-called auto exposure (AE) function, auto focus (AF) function, and auto white balance (AWB) function are installed in the endoscope 5115.

The camera-head control unit 5129 controls driving of the camera head 5119 on the basis of the control signal from the CCU 5153 received via the communication unit 5127. For example, on the basis of information of specifying a frame rate of a captured image and/or information of specifying exposure at the time of imaging, the camera-head control unit 5129 controls driving of the imaging element of the imaging unit 5123. Furthermore, for example, on the basis of information of specifying a magnification and focus of a captured image, the camera-head control unit 5129 appropriately moves the zoom lens and the focus lens of the lens unit 5121 via the driving unit 5125. The camera-head control unit 5129 may further include a function of storing information for identifying the lens barrel 5117 and the camera head 5119.

Note that, by arranging the configuration of the lens unit 5121, the imaging unit 5123, and the like in a sealed structure with high airtightness and waterproofness, the camera head 5119 can be made resistant to autoclave sterilization.

Next, a functional configuration of the CCU 5153 will be described. The communication unit 5173 is configured by a communication device for exchange of various types of information with the camera head 5119. The communication unit 5173 receives an image signal transmitted via the transmission cable 5179 from the camera head 5119. In this case, as described above, the image signal can be suitably transmitted by optical communication. In this case, corresponding to the optical communication, the communication unit 5173 is provided with a photoelectric conversion module that converts an optical signal into an electrical signal. The communication unit 5173 provides the image processing unit 5175 with an image signal converted into the electrical signal.

Furthermore, the communication unit 5173 transmits, to the camera head 5119, a control signal for controlling driving of the camera head 5119. The control signal may also be transmitted by optical communication.

The image processing unit 5175 performs various types of image processing on an image signal that is RAW data transmitted from the camera head 5119. The image processing includes various types of known signal processing such as, for example, development processing, high image quality processing (such as band emphasizing processing, super resolution processing, noise reduction (NR) processing, and/or camera shake correction processing), enlargement processing (electronic zoom processing), and/or the like. Furthermore, the image processing unit 5175 performs wave-detection processing on an image signal for performing AE, AF, and AWB.

The image processing unit 5175 is configured by a processor such as a CPU or a GPU, and the above-described image processing and wave-detection processing can be performed by the processor acting in accordance with a predetermined program. Note that, in a case where the image processing unit 5175 is configured by a plurality of GPUs, the image processing unit 5175 appropriately divides information regarding an image signal, and performs image processing in parallel by this plurality of GPUs.

The control unit 5177 performs various types of control related to imaging of the operative site by the endoscope 5115 and display of a captured image. For example, the control unit 5177 generates a control signal for controlling the driving of the camera head 5119. At this time, in a case where an imaging condition has been inputted by the user, the control unit 5177 generates a control signal on the basis of the input by the user. Alternatively, in a case where the endoscope 5115 is provided with the AE function, the AF function, and the AWB function, in response to a result of the wave-detection processing by the image processing unit 5175, the control unit 5177 appropriately calculates an optimal exposure value, a focal length, and white balance, and generates a control signal.

Furthermore, the control unit 5177 causes the display device 5155 to display an image of the operative site on the basis of the image signal subjected to the image processing by the image processing unit 5175. At this time, the control unit 5177 recognizes various objects in an operative site image by using various image recognition techniques. For example, by detecting a shape, a color, and the like of an edge of the object included in the operative site image, the control unit 5177 can recognize a surgical instrument such as forceps, a specific living site, bleeding, mist in using the energy treatment instrument 5135, and the like. When causing the display device 5155 to display the image of the operative site, the control unit 5177 uses the recognition result to superimpose and display various types of surgery support information on the image of the operative site. By superimposing and displaying the surgery support information and presenting to the operator 5181, it becomes possible to continue the surgery more safely and reliably.

The transmission cable 5179 connecting the camera head 5119 and the CCU 5153 is an electric signal cable corresponding to communication of an electric signal, an optical fiber corresponding to optical communication, or a composite cable of these.

Here, in the illustrated example, communication is performed by wire communication using the transmission cable 5179, but communication between the camera head 5119 and the CCU 5153 may be performed wirelessly. In a case where the communication between the two is performed wirelessly, since it becomes unnecessary to lay the transmission cable 5179 in the operating room, it is possible to eliminate a situation in which movement of medical staff in the operating room is hindered by the transmission cable 5179.

An example of the operating room system 5100 to which the technology according to the present disclosure can be applied has been described above. Note that, here, a description has been given to a case where a medical system to which the operating room system 5100 is applied is the endoscopic surgery system 5113 as an example, but the configuration of the operating room system 5100 is not limited to such an example. For example, the operating room system 5100 may be applied to a flexible endoscopic system for examination or a microsurgery system, instead of the endoscopic surgery system 5113.

The technique according to the present disclosure may be suitably applied to the image processing unit 5175 or the like among the configurations described above. By applying the technique according to the present disclosure to the surgical system described above, it is possible to segment an image with an appropriate field angle, for example, by editing a recorded surgical image. Furthermore, it is possible to learn a shooting situation such as a field angle so that important tools such as forceps can always be seen during shooting during the surgery, and it is possible to automate the shooting during the surgery by using learning results.

### REFERENCE SIGNS LIST

1 Imaging device
2 Camera control unit
3 Automatic shooting controller
11 Imaging unit
22 Camera signal processing unit
32 Face recognition processing unit
33 Processing unit
33A Learning unit
33B Field angle determination processing unit
34 Threshold value determination processing unit
36 Operation input unit
53A, 53B Learn button
100, 100A Information processing system

1. An information processing apparatus comprising a learning unit configured to acquire data, extract, from the data, data in at least a partial range in accordance with a predetermined input, and perform learning on a basis of the data in at least a partial range.

2. The information processing apparatus according to claim 1, wherein
the data is data based on image data corresponding to an image acquired during shooting.

3. The information processing apparatus according to claim 1, wherein
the predetermined input is an input indicating a learning start point.

4. The information processing apparatus according to claim 3, wherein
the predetermined input is further an input indicating a learning end point.

5. The information processing apparatus according to claim 4, wherein
the learning unit extracts data in a range from the learning start point to the learning end point.

6. The information processing apparatus according to claim 2, further comprising:
a learning target image data generation unit configured to perform predetermined processing on the image data, and generate a learning target image data obtained by reconstructing the image data on a basis of a result of the predetermined processing, wherein
the learning unit performs learning on a basis of the learning target image data.

7. The information processing apparatus according to claim 6, wherein
the learning target image data is image data in which a feature detected by the predetermined processing is symbolized.

8. The information processing apparatus according to claim 6, wherein
the predetermined processing is face recognition processing, and the learning target image data is image data in which a face region obtained by the face recognition processing is distinguished from other regions.

9. The information processing apparatus according to claim 6, wherein
the predetermined processing is posture detection processing, and the learning target image data is image data in which a feature point region obtained by the posture detection processing is distinguished from other regions.

10. The information processing apparatus according to claim 1, wherein
a learning model based on a result of the learning is displayed.

11. The information processing apparatus according to claim 1, wherein
the learning unit learns a correspondence between scenes and at least one of a shooting condition or an editing condition, for each of the scenes.

12. The information processing apparatus according to claim 11, wherein
the scene is a scene specified by a user.

13. The information processing apparatus according to claim 11, wherein
the scene is a positional relationship of a person with respect to a field angle.

14. The information processing apparatus according to claim 11, wherein
the shooting condition is a condition that may be adjusted during shooting.

15. The information processing apparatus according to claim 11, wherein
the editing condition is a condition that may be adjusted during shooting or a recording check.

16. The information processing apparatus according to claim 11, wherein
a learning result obtained by the learning unit is stored for each of the scenes.

17. The information processing apparatus according to claim 16, wherein
the learning result is stored in a server device capable of communicating with the information processing apparatus.

18. The information processing apparatus according to claim 16, further comprising:
a determination unit configured to make a determination using the learning result.

19. The information processing apparatus according to claim 2, further comprising:
an input unit configured to accept the predetermined input; and
an imaging unit configured to acquire the image data.

20. An information processing method comprising: acquiring data; extracting, from the data, data in at least a partial range in accordance with a predetermined input; and performing learning, by a learning unit, on a basis of the data in at least a partial range.

21. A program for causing a computer to execute an information processing method comprising: acquiring data; extracting, from the data, data in at least a partial range in accordance with a predetermined input; and performing learning, by a learning unit, on a basis of the data in at least a partial range.
